(19) United States
(12) Patent Application Publication
(10) Pub. No.: US 2014/0365306 A1
(43) Pub. Date: Dec. 11, 2014

(54) USER INFORMATION PROVIDING APPARATUS, USER INFORMATION PROVIDING METHOD, AND ADVERTISEMENT DISTRIBUTION SYSTEM

(71) Applicant: YAHOO JAPAN CORPORATION, Tokyo (JP)

(72) Inventors: Hiroshi OTA, Tokyo (JP); Nobuyuki AKASHI, Tokyo (JP); Hiroshi NISHIKAWA, Tokyo (JP)

(73) Assignee: YAHOO JAPAN CORPORATION, Tokyo (JP)

(21) Appl. No.: 14/010,963

(22) Filed: Aug. 27, 2013

(30) Foreign Application Priority Data
Jun. 11, 2013 (JP) 2013-123163

(51) Int. Cl. G06Q 30/02

(52) U.S. Cl. CPC G06Q 30/0261
USPC 705/14.58

(57) ABSTRACT

A user information providing apparatus according to an embodiment includes a database, an acquiring unit, an extracting unit, and a output unit. The database stores pieces of user information of a business operator. The acquiring unit acquires, as entry information, information of a place corresponding to the business operator and information of a wireless terminal which has entered the place. The extracting unit extracts a piece of user information of the business operator corresponding to the place which the wireless terminal has entered from the database, based on the entry information acquired. The output unit outputs the extracted piece of user information.

### CROSS-REFERENCE TO RELATED APPLICATIONS

The present application claims priority to and incorporates by reference the entire contents of Japanese Patent Application No. 2013-123163 filed in Japan on Jun. 11, 2013.

### BACKGROUND OF THE INVENTION

1. Field of the Invention

The present invention relates to a user information providing apparatus, a user information providing method, and an advertisement distribution system.

2. Description of the Related Art

In recent years, with the rapid spread of a network, such as the Internet, advertisements have been distributed through the network. As an aspect of the advertisement distribution, targeting advertisement has been known in which advertisements are distributed to the user with user information satisfying the distribution conditions (for example, the attributes, preference, and interest of the user) designated by the advertiser (for example, see Japanese Patent Application Laid-open No. 2009-223423).

However, in the advertisement distribution technique according to the related art, advertisements are distributed based on the user information possessed by the advertisement distributor and advertisement distribution intended by the advertiser is not likely to be performed.

### SUMMARY OF THE INVENTION

According to the exemplary embodiment, a user information providing apparatus includes a business operator information database, an entry information acquiring unit, a user information extracting unit, and a user information output unit. The business operator information database stores pieces of user information of a business operator. The entry information acquiring unit acquires, as entry information, information of a place corresponding to the business operator and information of a wireless terminal which has entered the place. The user information extracting unit extracts a piece of user information of the business operator corresponding to the place which the wireless terminal has entered from the business operator information database, based on the entry information acquired by the entry information acquiring unit. The user information output unit outputs the piece of user information extracted by the user information extracting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are diagrams illustrating a user information providing process according to an embodiment;

FIG. 2 is a diagram illustrating an example of the detailed structure of an advertisement distribution system according to the embodiment;

FIG. 3 is a diagram illustrating an example of the structure of a wireless apparatus according to the embodiment;

FIGS. 4A and 4B are diagrams illustrating a session establishment sequence between the wireless apparatus and a wireless terminal;

FIG. 5 is a diagram illustrating an example of the structure of a user information providing apparatus according to the embodiment;

FIG. 6 is a diagram illustrating an example of an associated user information table;

FIG. 7 is a diagram illustrating an example of a terminal detection table;

FIG. 8 is a diagram illustrating an example of a staying state determination table;

FIG. 9 is a diagram illustrating an example of an associated company information table;

FIG. 10 is a diagram illustrating an example of a correspondence information table;

FIG. 11 is a diagram illustrating an example of a user information table;

FIG. 12 is a diagram illustrating an example of the structure of an advertisement distribution apparatus according to the embodiment;

FIG. 13 is a diagram illustrating an example of an advertising information table;

FIG. 14 is a flowchart illustrating an information processing operation of the wireless apparatus according to the embodiment;

FIG. 15 is a flowchart illustrating an information processing operation of the user information providing apparatus according to the embodiment; and

FIG. 16 is a flowchart illustrating an information processing operation of the advertisement distribution apparatus according to the embodiment.

### DETAILED DESCRIPTION OF THE PREFERRED EMBODIMENTS

Hereinafter, a user information providing apparatus, a user information providing method, a user information providing program, and an advertisement distribution system according to embodiments of the invention will be described in detail with reference to the accompanying drawings. The user information providing apparatus, the user information providing method, the user information providing program, and the advertisement distribution system according to the invention are not limited by these embodiments. Hereinafter, a database is referred to as a DB.

1. User information Providing Process

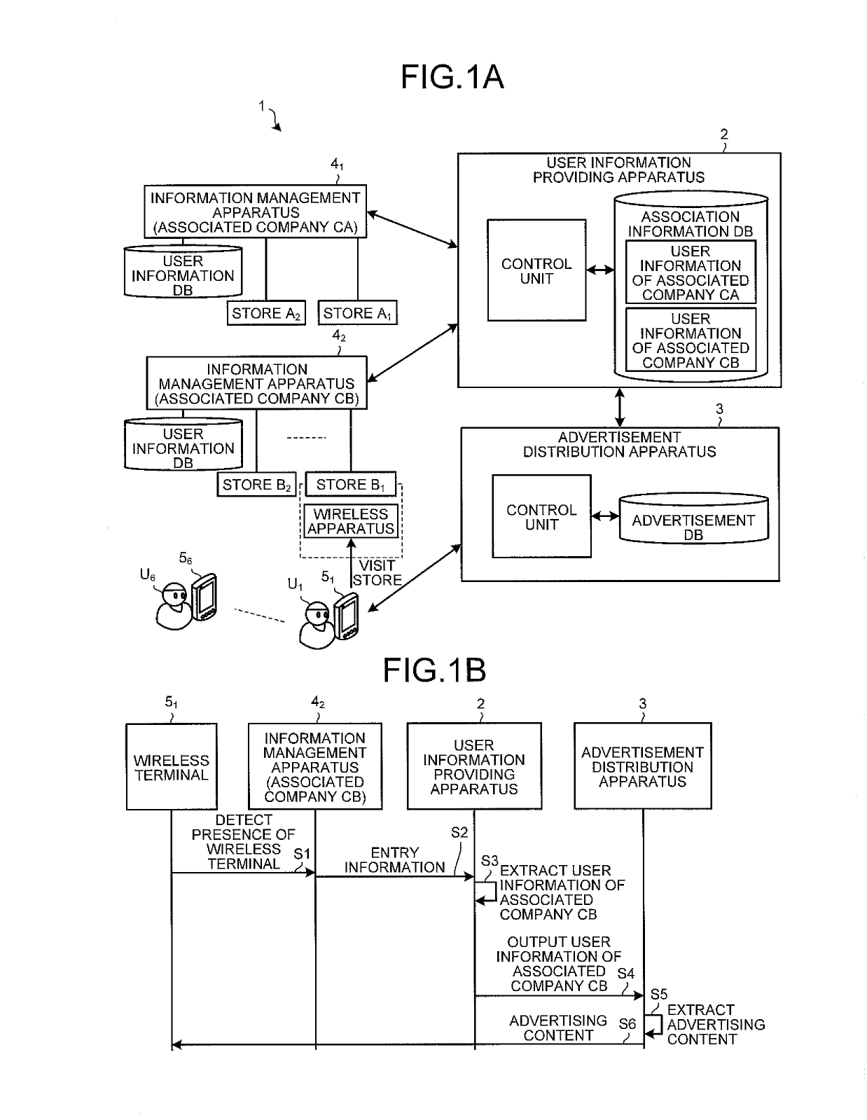

First, a user information providing process according to an embodiment will be described. FIGS. 1A and 1B are diagrams illustrating the user information providing process according to the embodiment. In this embodiment, the advertisement distribution system performs the user information providing process.

As illustrated in FIG. 1A, an advertisement distribution system 1 includes a user information providing apparatus 2, an advertisement distribution apparatus 3, and information management apparatuses 4₁ and 4₂. The user information providing apparatus 2 and the advertisement distribution apparatus 3 are managed and operated by an advertisement distributor. The information management apparatuses 4₁ and 4₂ (hereinafter, in some cases, generically referred to as an information management apparatus 4) are managed and operated by associated companies CA and CB (hereinafter, in some cases, generically referred to as an associated company C), respectively.

In addition, wireless terminals 5₁ to 5₆ illustrated in FIG. 1A are held by users U₁ to U₆ who visit the stores or facilities (hereinafter, referred to as stores) of the associated company C or purchase goods or services in the stores of the associated company C. Hereinafter, in some cases, the wireless terminals 5₁ to 5₆ are generically referred to as a wireless terminal 5 and the users U₁ to U₆ are generically referred to as a user U. In addition, the stores or facilities of the associated company C may be rephrased as the offices of the associated company C.

The wireless terminal 5 is a portable wireless terminal, such as a smart phone or a mobile personal computer (PC), and can communicate with various server apparatuses which are connected to a communication network (for example, the Internet) by wireless local area network (LAN) communication or mobile telephone communication.

The associated company C is a business operator who makes a cooperation contact with the advertisement distributor and is, for example, a distributor who has the stores providing goods or services. The associated company CA is the business operator who provides goods and services in stores A₁ and A₂ and the associated company CB is the business operator who provides goods or services in stores B₁ and B₂. The associated company C is not limited to the distributor, but may be, for example, a concert or sport promoter. In addition, the associated company C may be a company that operates commercial spaces, such as hotels, beauty shops, barbershops, hospitals, movie theaters, and complex leisure facilities.

The information management apparatus 4₁ includes a user information DB which stores user information possessed by the associated company CA and the information management apparatus 4₂ includes a user information DB which stores user information possessed by the associated company CB.

Examples of the user information stored in the user information DB include information (hereinafter, in some cases, referred to as behavior history information) about the store visit history or purchase history of the user U in the store of the associated company C and the identification information (hereinafter, referred to as a terminal ID) of the wireless terminal 5. The behavior history information also includes, for example, the identification information (hereinafter, referred to as a store ID) of the store of the associated company C.

The user information providing apparatus 2 acquires user information of the associated companies CA and CB from the information management apparatuses 4₁ and 4₂ and stores the user information in an association information DB (an example of a business operator information DB). When the user U with the wireless terminal 5 enters a place corresponding to the associated company C, a control unit of the user information providing apparatus 2 extracts user information of the associated company C corresponding to the place which the user U has entered from the association information DB and outputs the user information to the advertisement distribution apparatus 3.

The control unit of the user information providing apparatus 2 extracts a portion of or the entire user information of the associated company C as the user information of the associated company C corresponding to the place which the user U has entered from the association information DB and transmits the user information to the advertisement distribution apparatus 3.

As an extraction target of the user information, for example, the ‘user information of the entered user U’, ‘all user information of the associated company C’, and ‘all user information of the store which the user has entered’ can be set to each associated company C. In addition, the extraction target of the user information can be set for each period of time, each weather condition, each day of the week, each weekend, each month, and each entered user U.

When the user U with the wireless terminal 5 enters the place corresponding to the associated company C to which the ‘user information of the entered user U’ is set, the control unit of the user information providing apparatus 2 extracts a piece of user information of the entered user U among the pieces of user information of the associated company C corresponding to the place which the user U has entered from the association information DB. In this case, the control unit of the user information providing apparatus 2 may extract user information corresponding to the store which the user has entered from the association information DB.

When the user U with the wireless terminal 5 enters the place corresponding to the associated company C to which ‘all user information of the associated company C’ is set, the control unit of the user information providing apparatus 2 extracts, from the association information DB, all user information of the associated company C corresponding to the place which the user U has entered.

When the user U with the wireless terminal 5 enters the place corresponding to the associated company C to which ‘all user information of the entry store’ is set, the control unit of the user information providing apparatus 2 extracts, from the association information DB, a piece of user information related to the place (store) which the user U has entered among the pieces of user information of the associated company C corresponding to the place which the user U has entered.

For example, the ‘place corresponding to the associated company C’ is the inside of the store of the associated company C. However, the ‘place corresponding to the associated company C’ may include the inside of the store of the associated company C and an area around the store, and only the area around the store of the associated company C may be the ‘place corresponding to the associated company C’. In addition, the ‘place corresponding to the associated company C’ is not limited to the store of the associated company C or the area around the store, but may be a place related to the business of the associated company C. For example, the ‘place corresponding to the associated company C’ may include an area around the place where a poster including the information of the associated company C is put up, an area around the place where a digital signage terminal displaying the information of the associated company C is installed, and an area where the associated company C holds an event (for example, an event site or an arcade).

The advertisement distribution apparatus 3 includes an advertisement DB which stores advertising information. The advertising information stored in the advertisement DB is information which is provided by the advertiser and includes advertising content and distribution conditions. The distribution conditions include, for example, a condition that specifies the user U who has entered the store of the associated company C as a distribution destination and a condition that specifies the user U who has entered a specific store of the associated company C as the distribution destination.

A control unit of the advertisement distribution apparatus 3 acquires the advertising content corresponding to the user information of the associated company C acquired from the user information providing apparatus 2 from the advertisement DB and supplies the advertising content to the wireless terminal 5 of the entered user U. For example, it is assumed that the place which the user U has entered is the place corresponding to the associated company CA. In this case, the control unit of the advertisement distribution apparatus 3 acquires, from the advertisement DB, a piece of advertising content in which the user information of the associated company C acquired from the user information providing apparatus 2 satisfies the distribution conditions, among pieces of advertising content which are provided under the distribution conditions that specify the entered user U related to the associated company CA as the distribution destination, and supplies the acquired advertising content to the wireless terminal 5 of the entered user U.

When the ‘user information of the entered user U’ is transmitted from the user information providing apparatus 2, the control unit of the advertisement distribution apparatus 3 acquires the advertising content in which the user information of the entered user U satisfies the distribution conditions from the advertisement DB and supplies the acquired advertising content to the wireless terminal 5 of the entered user U.

When ‘all user information of the associated company C’ or ‘all user information of the store which the user has entered’ is transmitted from the user information providing apparatus 2, the control unit of the advertisement distribution apparatus 3 can determine, for example, the business conditions of the associated company C based on the user information of the associated company C. Then, the control unit of the advertisement distribution apparatus 3 can acquire the advertising content related to the determined business conditions from the advertisement DB and supply the acquired advertising content to the wireless terminal 5 of the entered user U.

The business conditions of the associated company C determined by the control unit of the advertisement distribution apparatus 3 include, for example, the type of business of the associated company C, the type of goods or services provided by the associated company C, the content of goods or services, and the number of goods or services provided. For example, the control unit of the advertisement distribution apparatus 3 may determine information about the goods or services provided by the associated company C or the store based on the user information of the associated company C, acquire the advertising content related to the provided goods or services from the advertisement DB, and supply the acquired advertising content to the wireless terminal 5 of the entered user U.

Here, an example of a process when the user U₁ of the wireless terminal 5₁ visits the store B₁ will be described with reference to FIG. 1B. In the following description, it is assumed that the ‘user information of the entered user U’ is set as an extraction target of the user information of the associated company CB.

When the user U₁ of the wireless terminal 5₁ visits the store B₁, a wireless apparatus which is installed in the store B₁ detects a wireless signal output from the wireless terminal 5₁ and outputs the terminal ID of the wireless terminal 5₁ from which the wireless signal is detected to the information management apparatus 4₂. Then, the information management apparatus 4₂ detects the presence of the wireless terminal 5₁ in the store B₁ (Step S1).

The information management apparatus 4₂ outputs entry information including the terminal ID of the wireless terminal 5₁ acquired from the wireless apparatus, the store ID of the store B₁, and the identification information (hereinafter, referred to as a company ID) of the associated company CB to the user information providing apparatus 2 (Step S2). In addition, the wireless apparatus installed in the store B₁ may directly output the entry information to the user information providing apparatus 2.

The control unit of the user information providing apparatus 2 extracts user information from the association information DB based on the entry information output from the information management apparatus 4₂ or the wireless apparatus (Step S3). Specifically, the control unit of the user information providing apparatus 2 extracts, from the association information DB, a piece of user information of the user U₁ corresponding to the terminal ID included in the entry information among the pieces of user information of the associated company CB corresponding to the company ID included in the entry information. The wireless apparatus may directly output the piece of user information to the user information providing apparatus 2.

In addition, the control unit of the user information providing apparatus 2 may extract user information of the user U₁ from the user information corresponding to the store B₁ of the associated company CB, as the user information extracted from the association information DB, based on the company ID and the store ID.

The control unit of the user information providing apparatus 2 outputs the extracted user information to the advertisement distribution apparatus 3 (Step S4). In this way, it is possible to provide the user information of the store B₁ which the user has entered or the user information of the associated company CB corresponding to the place which the user U₁ has entered to the advertisement distribution apparatus 3. Therefore, the advertisement distribution apparatus 3 can distribute the advertising content which designates the distribution conditions related to the associated company CB to the wireless terminal 5₁ of the entered user U₁. As a result, it is possible to perform high-accuracy targeting advertisement.

The control unit of the advertisement distribution apparatus 3 extracts the advertising content corresponding to the user information acquired from the user information providing apparatus 2 from the advertisement DB (Step S5) and provides the advertising content to the wireless terminal 5₁ of the entered user U₁ (Step S6). In this way, the advertisement distribution apparatus 3 can provide the advertising content related to the associated company CB to the wireless terminal 5₁ of the entered user U₁.

For example, the advertiser sends the advertising information including the distribution conditions which designate the associated company C and user attributes (for example, the preference or interest of the user U), which makes it possible to distribute the advertising content to the wireless terminal 5 of the user U having the designated user information among the users U who use the associated company C. In addition, the advertiser inserts the designation of the store into the distribution conditions, which makes it possible to distribute the advertising content to the wireless terminal 5 of the user U having the user information corresponding to the designated store.

Therefore, for example, when the manufacturer that provides goods to be placed in the store of the associated company C as the advertiser sends the advertising information to the advertisement distribution apparatus 3, it is possible to distribute the advertising content only to the user U of the associated company C and thus effectively and accurately promote goods.

Since the user information of the associated company C includes the purchase history of the goods of the manufacturer, it is possible to distribute the advertising content only to the user U which has purchased the goods advertised by the advertising content. Therefore, it is possible to effectively and accurately promote goods.

When the wireless terminal 5 has a global positioning system (GPS) function, the control unit of the user information providing apparatus 2 may detect the ‘place corresponding to the associated company C’ which the wireless terminal 5 has entered, based on information about the latitude and longitude detected by the wireless terminal 5, instead of the entry information obtained from the information management apparatus 4₂ or the wireless apparatus. In this case, a control unit of the wireless terminal 5 repeatedly acquires information about the latitude and longitude of the current position and transmits the acquired information to the user information providing apparatus 2. The user information providing apparatus 2 detect the ‘place corresponding to the associated company C’ which the wireless terminal 5 has entered, based on the information about the latitude and longitude transmitted from the wireless terminal 5.

When information in which the position information of the ‘place corresponding to the associated company C’ is associated with the company ID and the store ID is stored in a storage unit of the wireless terminal 5, the control unit of the wireless terminal 5 may compare the position information of the ‘place corresponding to the associated company C’ with the latitude and longitude of the current position to detect the company ID and store ID in the entry information. In this case, the control unit of the wireless terminal 5 transmits the entry information including the company ID and the store ID to the user information providing apparatus 2.

2. Structure of Advertisement Distribution System 1

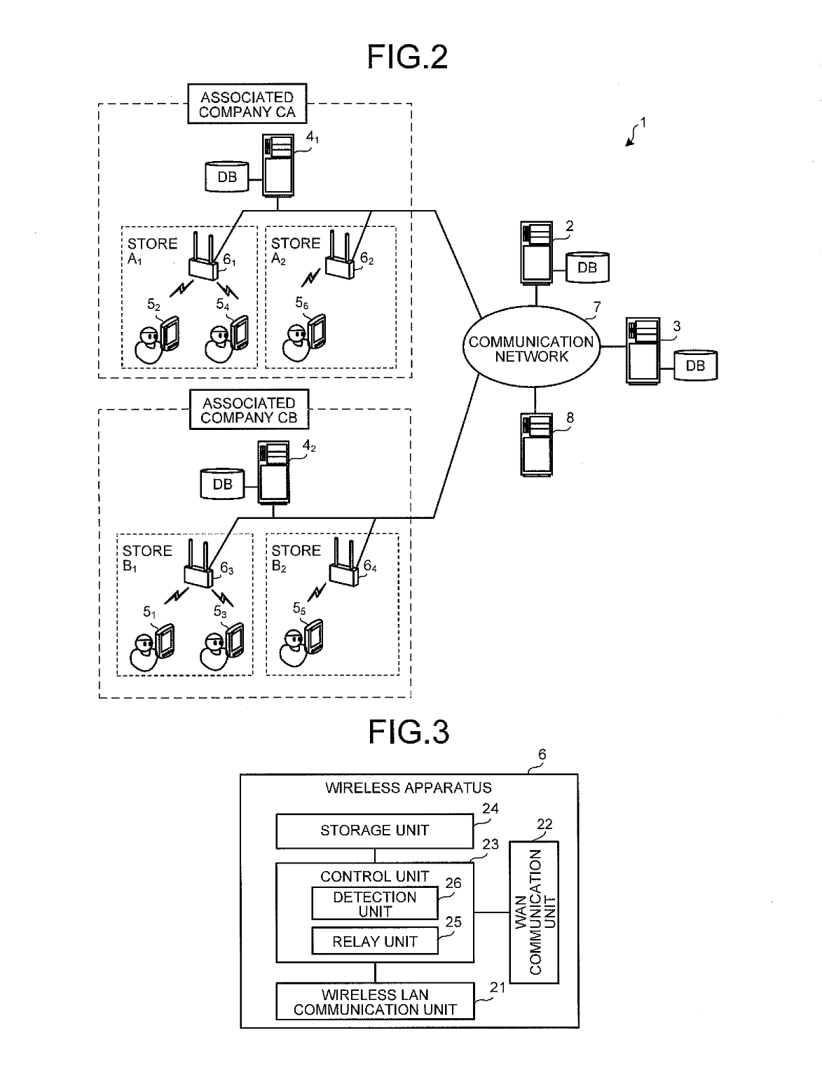

An example of the structure of the advertisement distribution system 1 according to the embodiment will be described with reference to FIG. 2. FIG. 2 is a diagram illustrating an example of the structure of the advertisement distribution system 1 according to the embodiment.

As illustrated in FIG. 2, the advertisement distribution system 1 includes the user information providing apparatus 2, the advertisement distribution apparatus 3, the information management apparatuses 4₁ and 4₂, the wireless terminals 5₁ to 5₆, wireless apparatuses 6₁ to 6₄ (hereinafter, in some cases, generically referred to as a wireless apparatus 6), and a site server 8.

The user information providing apparatus 2, the advertisement distribution apparatus 3, the information management apparatus 4, the wireless apparatus 6, and the site server 8 are connected through a communication network 7 such that they communicate with each other. The communication network 7 is a wide area network (WAN) such as the Internet.

In the example illustrated in FIG. 2, two associated companies CA and CB are illustrated, but one or three or more associated companies C may be provided. In addition, one or more wireless apparatuses 6 are installed in each store of the associated company C. In the example illustrated in FIG. 2, the wireless apparatuses 6₁ and 6₂ are installed in the stores A₁ and A₂ of the associated company CA and the wireless apparatuses 6₃ and 6₄ are installed in the stores B₁ and B₂ of the associated company CB.

The wireless terminal 5 is a terminal apparatus with a wireless LAN communication function, such as a smart phone or a mobile PC, and can communicate with the wireless apparatus 6 or a wireless WAN base station (not illustrated). The wireless WAN base station is connected to the communication network 7.

The wireless apparatus 6 is, for example, a wireless LAN access point. However, when the wireless terminal 5 can transmit a terminal ID using near field communication (NFC), the wireless apparatus 6 may be an NFC apparatus.

The NEC has a communication area from 1 meter to several centimeters. Examples of the NFC include Felica and ISO/IEC14443 (MIDARE). The NEC is not limited to communication using electric waves, but may be, for example, infrared communication, visible light communication, or acoustic communication.

The wireless apparatus 6 includes an indirect output mode which outputs the entry information to the user information providing apparatus 2 through the information management apparatus 4 and a direct output mode which outputs the entry information to the direct user information providing apparatus 2 through the communication network 7, without passing through the information management apparatus 4. In the following description, it is assumed that the wireless apparatus 6 operates in the direct output mode. However, the wireless apparatus 6 may operate in the indirect output mode.

The site server 8 is managed and operated by the advertisement distributor and provides, for example, web pages in various categories to the wireless terminal 5 through the communication network 7 in response to the access of the wireless terminal 5 through the communication network 7.

In addition, the site server 8 acquires the advertising content corresponding to the user ID of the user U of the accessed wireless terminal 5 from the advertisement distribution apparatus 3, inserts the advertising content into a web page, and provides the web page to the wireless terminal 5. The user ID of the user U is, for example, a login ID to the site server 8.

Next, the structures of the wireless apparatus 6, the user information providing apparatus 2, the advertisement distribution apparatus 3, and the information management apparatus 4 will be sequentially described.

3. Structure of Wireless Apparatus 6

First, the structure of the wireless apparatus 6 will be described in detail. FIG. 3 is a diagram illustrating an example of the structure of the wireless apparatus 6. The wireless apparatus 6 illustrated in FIG. 3 is a wireless LAN access point and includes a wireless LAN communication unit 21, a WAN communication unit 22, a control unit 23, and a storage unit 24.

The wireless LAN communication unit 21 is installed such that the communication area (hereinafter, referred to as an AP communication area) thereof is the place (for example, the inside of the store of the associated company C or an area around the store) corresponding to the associated company C. The wireless LAN communication unit 21 is a communication interface which performs wireless LAN communication and transmits and receives information to and from the wireless terminal 5 with a wireless LAN communication function. As the wireless LAN, for example, there is a wireless LAN defined by IEEE802.11, but the wireless LAN is not limited to the standard.

The WAN communication unit 22 is connected to the communication network 7 and transmits and receives information to and from the user information providing apparatus 2, the information management apparatus 4, and the site server 8 through the communication network 7. The WAN communication unit 22 is connected to the communication network 7 by wire or wirelessly.

The control unit 23 includes a relay unit 25 which performs an information relay process and a detection unit 26 which performs a process of detecting the wireless terminal 5, and implements or performs the following information processing function or operation. The control unit 23 is implemented by an integrated circuit, such as an application specific integrated circuit (ASIC) or a field programmable gate array (FPGA).

A central processing unit (CPU) or a micro processing unit (MPU) in the control unit 23 executes a program stored in a storage device of the control unit 23, using a RAM as a work area, to function as the relay unit 25 and the detection unit 26. The internal structure of the control unit 23 is not limited to the above, but the control unit 23 may have any structure as long as it can perform the following information processing.

For example, the relay unit 25 transmits information which is acquired from the wireless terminal 5 through the wireless LAN communication unit 21 from the WAN communication unit 22 to the site server 8 and transmits information which is acquired from the advertisement distribution apparatus 3 or the site server 8 through the WAN communication unit 22 from the wireless LAN communication unit 21 to the wireless terminal 5.

The information is transmitted from the wireless apparatus 6 to the site server 8 by, for example, packet communication in which the address of the communication network 7 allocated to the wireless apparatus 6 is a transmission source address and the address of the communication network 7 allocated to the site server 8 is a transmission destination address. The address of the communication network 7 is, for example, the address allocated to the WAN communication unit 22.

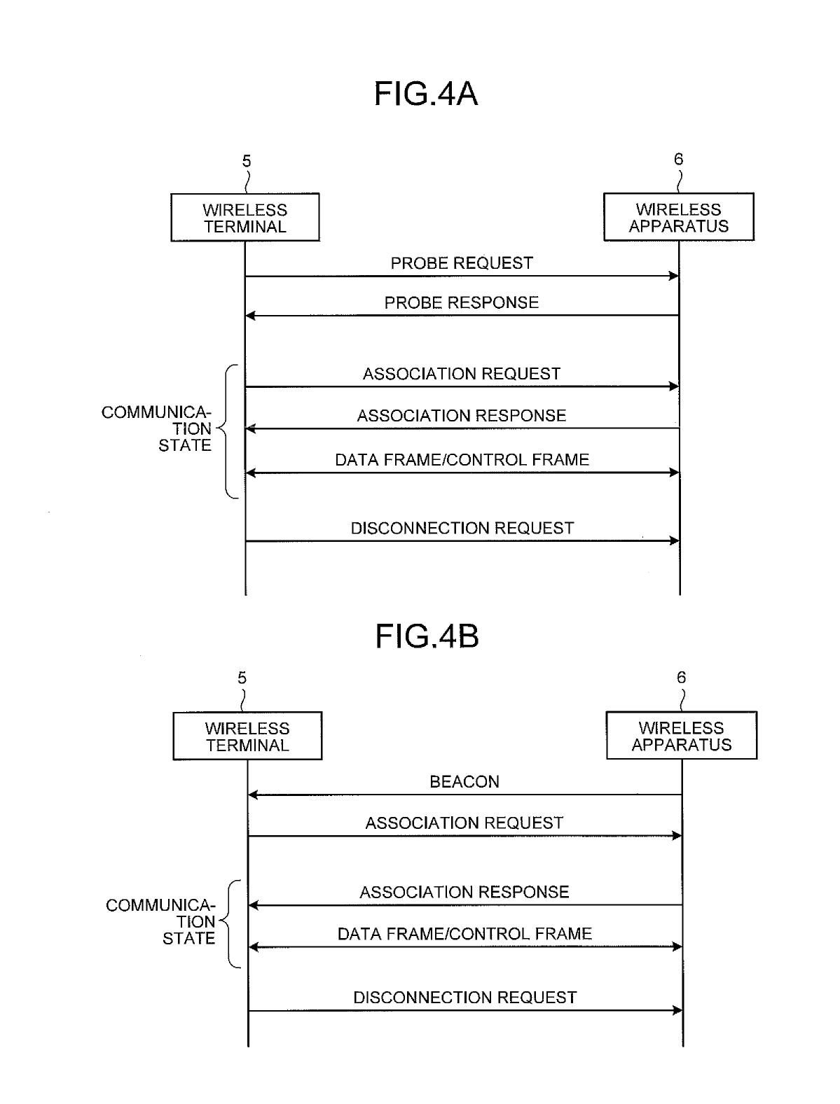

The detection unit 26 acquires a wireless packet (an example of the wireless signal) transmitted from the wireless terminal 5 through the wireless LAN communication unit 21 to detect the presence of the wireless terminal 5. FIGS. 4A and 4B are diagrams illustrating a session establishment sequence between the wireless apparatus 6 and the wireless terminal 5.

In the example illustrated in FIG. 4A, the wireless terminal 5 periodically transmits a wireless packet called a probe request using, for example, broadcasting and the detection unit 26 acquires the wireless packet through the wireless LAN communication unit 21 to detect the presence of the wireless terminal 5.

The probe request includes a service set identifier (SSID). When the SSID of the probe request is identical to the SSID of the wireless LAN communication unit 21, the detection unit 26 transmits a probe response to the wireless terminal 5. When the wireless terminal 5 which receives the probe response is set to automatic communication, it changes to a communication state.

As illustrated in FIG. 4A, the wireless terminal 5 is changed to the communication state by establishing the session using an association request and an association response. Then, a data frame or a control frame is transmitted and received between the wireless terminal 5 and the wireless LAN communication unit 21 and the wireless terminal 5 changes to the communication state.

When a disconnection request is received from the wireless terminal 5 or when it is difficult to transmit and receive the wireless packet between the wireless terminal 5 and the wireless LAN communication unit 21, the communication state is cancelled. In the communication state, the detection unit 26 repeatedly receives the wireless packet to detect the presence of the wireless terminal 5 until the communication state is cancelled.

As illustrated in FIG. 4B, the detection unit 26 broadcasts, for example, a wireless packet called a beacon to the wireless terminal 5 which does not periodically transmit the wireless packet through the wireless LAN communication unit 21 and receives an association request which is a response to the beacon to detect the presence of the wireless terminal 5.

When receiving the association request, the detection unit 26 transmits the association response to the wireless terminal 5 to establish the session and the wireless terminal 5 communicates with the wireless LAN communication unit 21. When there is a disconnection request from the wireless terminal 5 or when it is difficult to transmit and receive the wireless packet between the wireless terminal 5 and the wireless LAN communication unit 21, the communication state is cancelled. In the example illustrated in FIG. 4A, in the communication state, the detection unit 26 repeatedly receives the wireless packet to detect the presence of the wireless terminal 5 until the communication state is cancelled.

For example, when it is determined that the wireless terminal 5 is detected, the detection unit 26 transmits detection information to the user information providing apparatus 2 through the WAN communication unit 22 and the communication network 7. Specifically, the detection unit 26 extracts the terminal ID in the wireless packet transmitted from the wireless terminal 5 and detects radio field strength.

The terminal ID is, for example, a MAC address of the wireless LAN communication unit of the wireless terminal 5, is added to the wireless packet, and is transmitted from the wireless terminal 5. The radio field strength is of the wireless signal received by the wireless apparatus 6. The radio field strength may be received signal strength indication (RSSI) acquired by the wireless terminal 5. In this case, a wireless signal including information about the radio field strength is transmitted from the wireless terminal 5 to the wireless apparatus 6.

The detection unit 26 periodically (for example, at an interval of one second) transmits information including the store ID as the detection information to the user information providing apparatus 2, in addition to the terminal ID of the wireless terminal 5 and the information about the radio field strength. The store ID is the identification information of the store in which the wireless apparatus 6 is installed. For example, the network address of the communication network 7 allocated to the WAN communication unit 22 may be used as the store ID. The store ID may be the identification information of the store and is not limited to the network address.

4. User Information Providing Apparatus 2

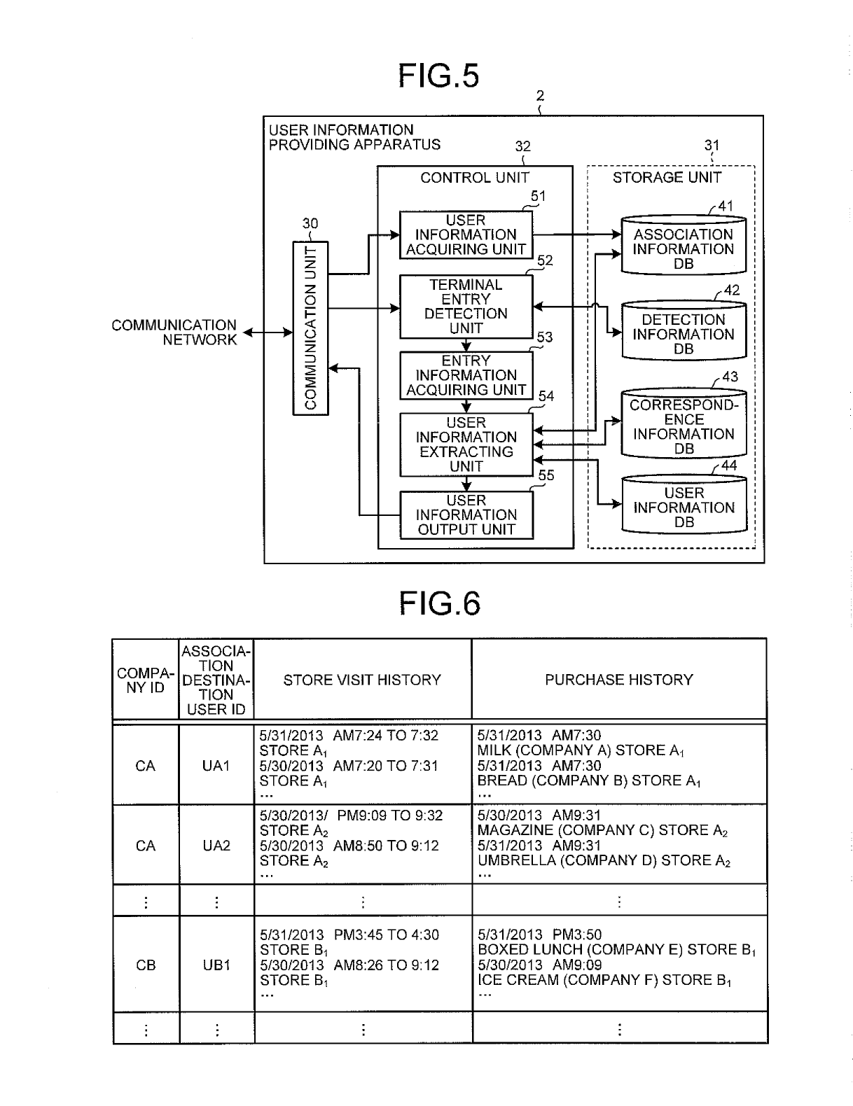

Next, the structure of the user information providing apparatus 2 will be described in detail. FIG. 5 is a diagram illustrating an example of the structure of the user information providing apparatus 2. As illustrated in FIG. 5, the user information providing apparatus 2 includes a communication unit 30, a storage unit 31, and a control unit 32.

The storage unit 31 includes an association information DB 41 (an example of a business operator information DB), a detection information DB 42, a correspondence information DB 43, and a user information DB 44. The control unit 32 includes a user information acquiring unit 51, a terminal entry detection unit 52, an entry information acquiring unit 53, a user information extracting unit 54, and a user information output unit 55.

The communication unit 30 is an interface such as a network interface card (NIC). The control unit 32 transmits and receives various kinds of information to and from the advertisement distribution apparatus 3, the information management apparatus 4, and the wireless apparatus 6 through the communication unit 30 and the communication network 7.

The association information DB 41, the detection information DB 42, the correspondence information DB 43, and the user information DB 44 are a hard disk, a semiconductor memory element such as a random access memory (RAM) or a flash memory, or a storage device such as an optical disk. The association information DB 41, the detection information DB 42, the correspondence information DB 43, and the user information DB 44 may be integrated into one DB. The correspondence information DB 43 and the user information DB 44 may not be provided and the control unit 32 may acquire the information in the correspondence information DB and the user information DB provided in the advertisement distribution apparatus 3 from the advertisement distribution apparatus 3.

The control unit 32 is implemented by, for example, an integrated circuit such as an ASIC or an FPGA. A CPU or an MPU in the control unit 32 executes the program stored in a storage device of the control unit 32 using the RAM as a work area to function as the user information acquiring unit 51, the terminal entry detection unit 52, the entry information acquiring unit 53, the user information extracting unit 54, and the user information output unit 55.

The structure of the control unit 32 is not limited to the above, but the control unit 32 may have any structure as long as it can perform the following information processing. In addition, the user information providing apparatus 2 includes a reading unit (not illustrated). The control unit 32 reads a program which is recorded on a recording medium to the internal storage device through the reading device and executes the program. In this way, it is possible to implement the functions of the control unit 32. Examples of the recording medium include an optical disk, a flexible disk, and a hard disk.

User Information Acquiring Unit 51

The user information acquiring unit 51 acquires the user information possessed by a plurality of associated companies CA and CB from the information management apparatuses 4₁ and 4₂ and stores the user information in the association information DB 41. In each associated company C, the user information is sequentially updated and the user information acquiring unit 51 acquires the updated user information and updates the user information in the association information DB 41.

FIG. 6 is a diagram illustrating an example of an associated user information table stored in the association information DB 41. As illustrated in FIG. 6, the associated user information table is information in which a ‘company ID’, an ‘association destination user ID’, and behavior history information, such as a ‘store visit history’ and a ‘purchase history’ are associated with each other.

The ‘company ID’ is the identification information of the associated company C. In the example illustrated in FIG. 6, ‘CA’ is the company ID of the associated company CA and ‘CB’ is the company ID of the associated company CB. In the example illustrated in FIG. 6, the user information of the associated company CA and the user information of the associated company CB are set in the same associated user information table. However, the management of the user information by the associated company C is not limited to the above-mentioned structure.

For example, the associated user information table may be provided for each associated company C and the user information may be set in the associated user information table corresponding to each associated company C. In addition, the association information DB may be provided for each associated company C. In this case, it is possible to separately manage the user information of each associated company C.

The ‘association destination user ID’ is a user ID unique to each associated company C and is allocated to the user U who uses the associated company C. In the example illustrated in FIG. 6, ‘UA1’ and ‘UA2’ are allocated in the associated company CA and ‘UB1’ is allocated in the associated company CB. A set of the company ID and the association destination user ID may be unique information and the association destination user ID of the associated company CA and the association destination user ID of the associated company CB may overlap each other.

The ‘store visit history’ is the store visit history of the user U to the store of the associated company C. For example, as illustrated in FIG. 6, the store visit history includes information such as a store visit date and time and the store visited by the user. In addition, the ‘purchase history’ is the purchase history of the user U at the store of the associated company C. For example, as illustrated in FIG. 6, the purchase history includes information such as a purchase date and time, purchased goods (including a manufacturer name and a product name), and the store where the user purchases goods.

The user information of the associated company C is not limited to that illustrated in FIG. 6, but may be information, such as age, sex, preference, the number of times the user visits the store, and the average amount of purchase. In addition, the user information may be information which is different for each associated company C.

Terminal Entry Detection Unit 52

The terminal entry detection unit 52 detects the entry of the wireless terminal 5 to the place corresponding to the associated company C, based on the detection information transmitted from the wireless apparatus 6 which has the place corresponding to the associated company C as an AP communication area.

The terminal entry detection unit 52 acquires the detection information transmitted from the wireless apparatus 6 and updates the terminal detection table in the detection information DB 42 based on the store ID, the terminal ID, and the radio field strength information included in the detection information.

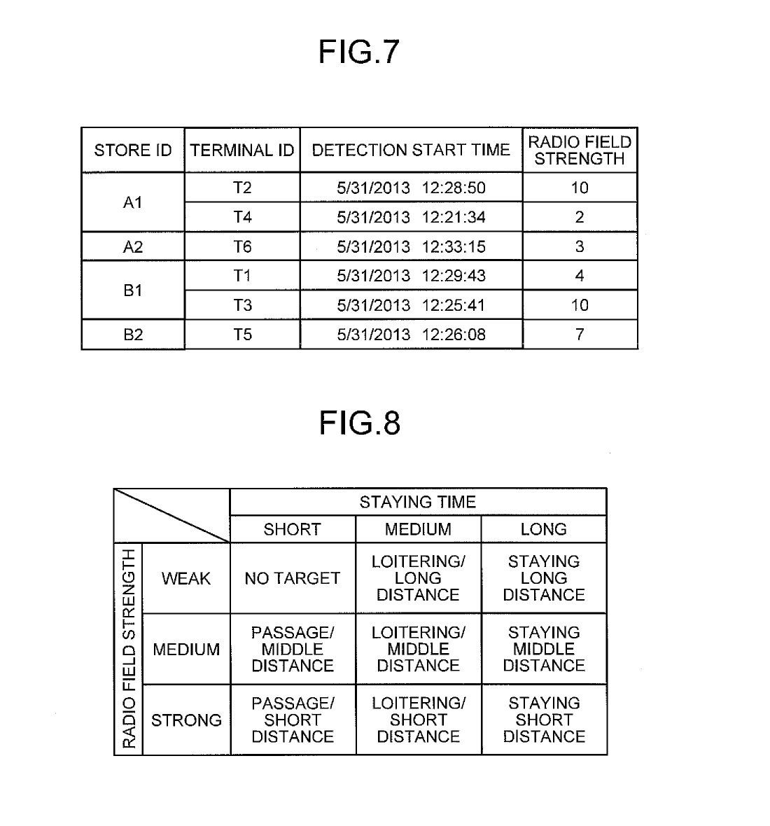

FIG. 7 is a diagram illustrating an example of the terminal detection table. As illustrated in FIG. 7, the terminal detection table includes information in which a ‘terminal ID’, a ‘detection start time’, and ‘radio field strength’ are associated with each other for each ‘store ID’. The ‘store ID’ is the identification information of the store in which the wireless apparatus 6 is installed and is, for example, the network address of the wireless apparatus 6. The ‘terminal ID’ is the identification information of the wireless terminal 5 detected by the wireless apparatus 6 and is, for example, a MAC address of the LAN wireless communication unit of the wireless terminal 5.

The ‘detection start time’ is the time when the wireless terminal 5 is detected in the AP communication area. The terminal entry detection unit 52 can compare the detection start time with the present time to detect the staying time of the wireless terminal 5 in the AP communication area.

The ‘radio field strength’ is the radio field strength of the wireless packet of the wireless terminal 5 detected by the wireless apparatus 6 and is, for example, average radio field strength from the detection start time.

The terminal entry detection unit 52 determines that the wireless terminal 5 has entered the place corresponding to the associated company C when the staying time and the radio field strength of the wireless terminal 5 in the AP communication area satisfy predetermined determination conditions, based on the terminal detection table in the detection information DB 42.

For example, when the staying time of the wireless terminal 5 in the AP communication area is less than a first time threshold value or when the radio field strength of the wireless terminal 5 is less than a first strength threshold value, the terminal entry detection unit 52 determines that the wireless terminal 5 does not enter the place corresponding to the associated company C.

When the staying time of the wireless terminal 5 in the AP communication area is equal to or greater than the first time threshold value and is less than a second time threshold value and the radio field strength of the wireless terminal 5 is equal to or greater than the first strength threshold value and is less than a second strength threshold value, the terminal entry detection unit 52 determines that the wireless terminal 5 does not enter the place corresponding to the associated company C.

On the other hand, when the wireless terminal 5 has the staying time and the radio field strength other than the above-mentioned state, the terminal entry detection unit 52 determines that the wireless terminal 5 has entered the place corresponding to the associated company C. In addition, the terminal entry detection unit 52 may determine the type of staying state based on the staying time and the radio field strength with reference to a staying state determination table stored in the detection information DB 42.

In the staying state determination table, the type of staying state is associated with the length of the staying time and the radio field strength. FIG. 8 is a diagram illustrating an example of the staying state determination table. In the example of the staying state determination table illustrated in FIG. 8, the type of staying state includes ‘passage/middle distance’, ‘passage/short distance’, ‘loitering/long distance’, ‘loitering/middle distance’, ‘loitering/short distance’, ‘staying/long distance’, ‘staying/middle distance’, and ‘staying/short distance’. The type of staying state illustrated in FIG. 8 is an illustrative example and the staying state determination table may be set by other classification methods.

In the staying state determination table, ‘short’ indicates a case in which the staying time is equal to or greater than the first time threshold value and is less than the second time threshold value, ‘medium’ indicates a case in which the staying time is equal to or greater than the second time threshold value and is less than a third time threshold value, and ‘long’ indicates a case in which the staying time is equal to or greater than the third time threshold value.

In addition, in the staying state determination table, ‘weak’ indicates a case in which the radio field strength is equal to or greater than the first strength threshold value and is less than the second strength threshold value, ‘medium’ indicates a case in which the radio field strength is equal to or greater than the second strength threshold value and is less than a third strength threshold value, and ‘strong’ indicates a case in which the radio field strength is equal to or greater than the third strength threshold value. In this embodiment, the ‘staying time’ and the ‘radio field strength’ are each classified into three states, but they may be classified into two states or four or more states.

FIG. 8 illustrates an example of the staying state determination table when the AP communication area is set so as to include a portion of the outside of the store in addition to the internal space of the store. For example, ‘passage’ is the staying state of the wireless terminal 5 when it is presumed that the user U of the wireless terminal 5 passes through an area around the store, which is a space outside the store, in the AP communication area. In addition, ‘loitering’ is the staying state of the wireless terminal 5 when it is presumed that the user U of the wireless terminal 5 is loitering around the store in the AP communication area. Furthermore, ‘staying’ is the staying state of the wireless terminal 5 when it is presumed that the user U of the wireless terminal 5 is staying in the store in the AP communication area.

When it is determined that the wireless terminal 5 has entered the place corresponding to the associated company C, the terminal entry detection unit 52 outputs entry information and staying state information to the entry information acquiring unit 53. The entry information includes the store ID and the terminal ID. The staying state information indicates the type of staying state.

The terminal entry detection unit 52 may output only the entry information to the entry information acquiring unit 53 at the time when the staying time and the radio field strength of the wireless terminal 5 in the AP communication area are greater than a predetermined time threshold value and a predetermined strength threshold value.

Threshold value information, such as the time threshold value or the strength threshold value, may be adjusted for each store ID or each terminal ID. For example, the operator of the associated company C can transmit the set value of the threshold value information for each store from the information management apparatus 4 or the terminal apparatus (not illustrated) to the user information providing apparatus 2, and the terminal entry detection unit 52 stores the threshold value information acquired through the communication unit 30 in the detection information DB 42. In addition, similarly, the user U of the wireless terminal 5 can operate the wireless terminal 5 to transmit the set value of the threshold value information for each terminal from the wireless terminal 5 to the user information providing apparatus 2, and the terminal entry detection unit 52 stores the threshold value information for each terminal which is acquired through the communication unit 30 in the detection information DB 42.

The terminal entry detection unit 52 or the detection information DB 42 may be provided in the wireless apparatus 6 such that the entry information or the staying state information can be output from the wireless apparatus 6. In this case, the control unit 23 of the wireless apparatus 6 transmits the entry information or the staying state information to the user information providing apparatus 2 and the entry information acquiring unit 53 of the user information providing apparatus 2 acquires the entry information or the staying state information. The adjustment of the threshold value information is performed for the wireless apparatus 6.

When the wireless terminal 5 has a GPS function, the terminal entry detection unit 52 may detect the entry of the wireless terminal 5 to the place corresponding to the associated company C based on the information about the latitude and longitude transmitted from the wireless terminal 5. In this case, position range information in which the store ID and information indicating an entry detection range are associated with each other is stored in the detection information DB 42 in advance. The terminal entry detection unit 52 extracts the store ID corresponding to the entry detection range including the latitude and longitude of the wireless terminal 5 from the position range information. In addition, the control unit of the wireless terminal 5 periodically acquires the latitude and longitude of the current position from the position detection unit of the wireless terminal 5 and transmits the acquired latitude and longitude to the user information providing apparatus 2.

When the entry information including the company ID and the store ID is transmitted from the wireless terminal 5, the control unit 32 of the user information providing apparatus 2 may detect the entry of the wireless terminal 5 to the place corresponding to the associated company C based on the entry information from the wireless terminal 5. In this case, the wireless terminal 5 includes a storage unit storing information in which the position information of the ‘place corresponding to the associated company C’ is associated with the company ID and the store ID. The control unit of the wireless terminal 5 compares the position information of the ‘place corresponding to the associated company C’ with the latitude and longitude of the current position based on the information stored in the storage unit to detect the company ID and the store ID of the place which the wireless terminal has entered. Then, the control unit of the wireless terminal 5 transmits the entry information including the company ID and the store ID to the user information providing apparatus 2.

Entry Information Acquiring Unit 53

The entry information acquiring unit 53 acquires the entry information or the staying state information from the terminal entry detection unit 52. The entry information includes the terminal ID of the wireless terminal 5 which has entered the place corresponding to the associated company C and the store ID of the place corresponding to the associated company C which the wireless terminal 5 has entered. When the entry information or the staying state information is output from the wireless apparatus 6, the entry information acquiring unit 53 may acquire the entry information or the staying state information from the wireless apparatus 6.

The entry information acquiring unit 53 outputs the acquired entry information or staying state information to the user information extracting unit 54. In addition, the entry information acquiring unit 53 may not be provided and the terminal entry detection unit 52 may directly output the entry information or the staying state information to the user information extracting unit 54.

User Information Extracting Unit 54

The user information extracting unit 54 extracts user information of the associated company C corresponding to the place which the wireless terminal 5 has entered from the association information DB 41, based on the entry information acquired from the entry information acquiring unit 53.

Specifically, the user information extracting unit 54 specifies the company ID of the associated company C corresponding to the place which the wireless terminal 5 has entered, based on the store ID included in the entry information. The company ID is specified based on the associated company information table stored in the association information DB 41.

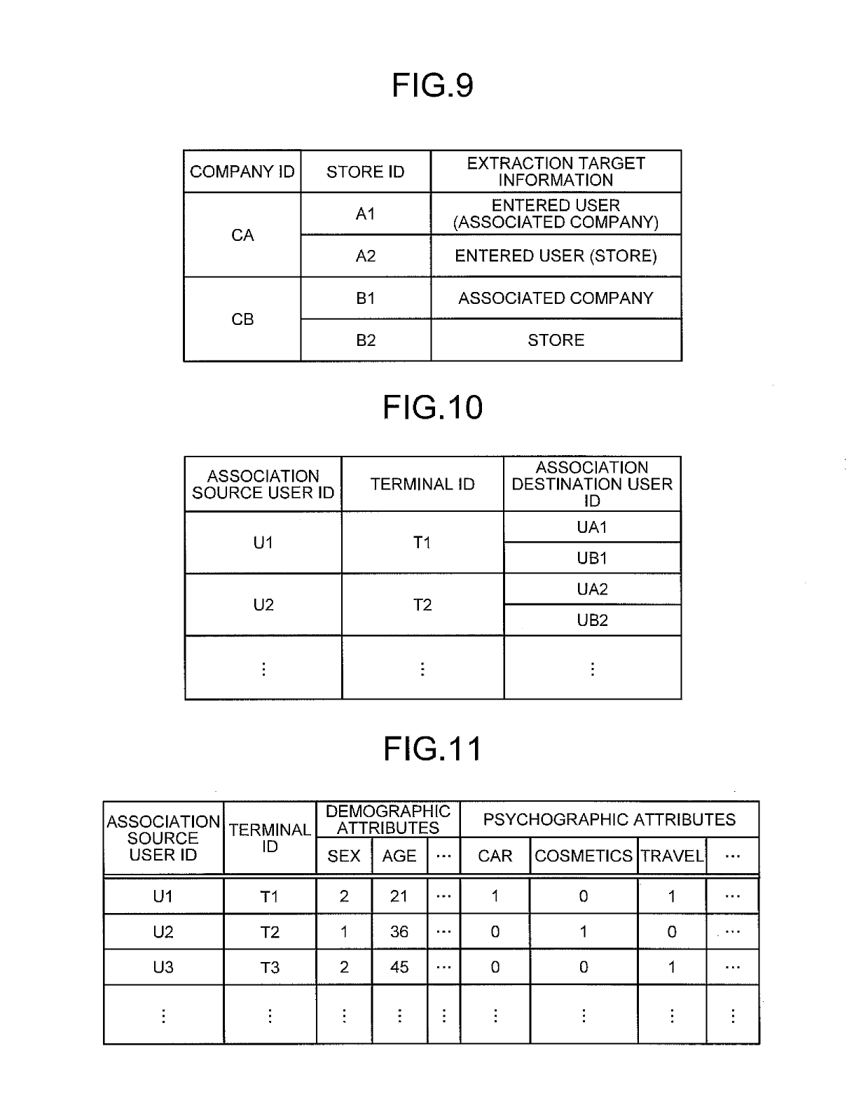

FIG. 9 is a diagram illustrating an example of the associated company information table. As illustrated in FIG. 9, the associated company information table includes information in which the ‘store ID’ and the ‘extraction target information’ are associated with the ‘company ID’. For example, the store IDs ‘A1’ and ‘A2’ of the stores A₁ and A₂ are associated with a company ID ‘CA’ and the store IDs ‘B1’ and ‘B2’ of the stores B₁ and B₂ are associated with a company ID ‘CB’. For example, when the store ID ‘A1’ is included in the entry information, the user information extracting unit 54 specifies that the company ID of the associated company C corresponding to the place which the wireless terminal 5 has entered is ‘CA’.

In the example illustrated in FIG. 9, an ‘entered user (associated company)’ is associated with the store ID ‘A1’, an ‘entered user (store)’ is associated with the store ID ‘A2’, a ‘associated company’ is associated with the store ID ‘B1’, and a ‘store’ is associated with the store ID ‘B2’.

Extraction target information ‘entered user (associated company)’ indicates that the user information extracting unit 54 extracts a piece of user information of the associated company C which the user U has entered among the pieces of user information of the entered user U. In addition, extraction target information ‘entered user (store)’ indicates that the user information extracting unit 54 extracts a piece of user information of the store which the user U has entered, among the pieces of user information of the entered user U.

In addition, extraction target information ‘associated company’ indicates that the user information extracting unit 54 extracts all user information of the associated company C which the user U has entered. Extraction target information ‘store’ indicates that the user information extracting unit 54 extracts all user information of the store which the user U has entered. For example, the user information acquiring unit 51 sets the extraction target information in the associated company information table in response to a request from the apparatus (for example, the information management apparatuses 4₁ and 4₂) of the associated company C.

When the extraction target information corresponding to the company ID and the store ID is the ‘entered user (associated company)’ or the ‘entered user (store)’, the user information extracting unit 54 specifies the user ID (association destination user ID) of the associated company C corresponding to the place which the wireless terminal 5 has entered, based on the terminal ID included in the entry information. The specification operation is performed based on the correspondence information table stored in the correspondence information DB 43.

FIG. 10 is a diagram illustrating an example of the correspondence information table. As illustrated in FIG. 10, the correspondence information table includes information in which the ‘terminal ID’ and the ‘association destination user ID’ are associated with an ‘association source user ID’. The ‘association source user ID’ is the identification information of the user U set by the advertisement distributor and is, for example, the login ID of the site server 8. For example, when the entry information includes a terminal ID ‘T1’, the user information extracting unit 54 determines that the association destination user ID is ‘UA1’ and the association source user ID is ‘U1’.

When the company ID and the store ID (the association destination user ID, if necessary) are specified based on the entry information, the user information extracting unit 54 extracts the user information corresponding to the specified company ID from the associated user information table stored in the association information DB 41.

For example, it is assumed that the associated user information table is in the state illustrated in FIG. 6 and the company ID and the association destination user ID specified by the user information extracting unit 54 are ‘CA’ and ‘UA1’. In this case, the user information extracting unit 54 extracts store visit information ‘May 31, 2013 7:24 AM-7:32 AM store A₁’ and a purchase history ‘May 31, 2013 7:30 AM milk (company A) store A₁’ as the user information from the associated user information table.

It is assumed that the company ID, the store ID, and the association destination user ID specified by the user information extracting unit 54 are ‘CA’, ‘A2’, and ‘UA2’, respectively. In this case, the user information extracting unit 54 extracts a piece of user information, such as store visit information and a purchase history including the information of ‘store A₂’, among the pieces of user information corresponding to ‘UA2’ from the associated user information table.

It is assumed that the company ID and the store ID specified by the user information extracting unit 54 are ‘CB’ and ‘B1’, respectively. In this case, the user information extracting unit 54 extracts all user information corresponding to the company ID ‘CB’ from the associated user information table.

It is assumed that the company ID and the store ID specified by the user information extracting unit 54 are ‘CB’ and ‘B2’, respectively. In this case, the user information extracting unit 54 extracts store visit information and a purchase history including the information of the ‘store B₂’ among the pieces of user information corresponding to the company ID ‘CB’ from the associated user information table.

As such, the user information extracting unit 54 extracts only the user information of the associated company C corresponding to the place which the wireless terminal 5 has entered and does not extract the user information other than the associated company C corresponding to the place which the wireless terminal 5 has entered. Therefore, access to the user information is limited for each associated company C and it is possible to ensure security for each associated company C.

When the piece of user information of the entered user U among the pieces of user information in the associated company C corresponding to the place which the wireless terminal 5 has entered is not stored in the association information DB 41, the user information extracting unit 54 can acquire the correspondence user information from the user information table stored in the user information DB 44.

Even when the number of store visit histories or purchase histories included in the user information of the entered user U which is stored in the association information DB 41 is equal to or less than a predetermined value, the user information extracting unit 54 can acquire the correspondence user information from the user information table.

FIG. 11 is a diagram illustrating an example of the user information table. As illustrated in FIG. 11, the user information table includes information in which a ‘terminal ID’, ‘demographic attributes’, and ‘psychographic attributes’ are associated with each ‘association source user ID’. In addition, an access log to the site server 8 managed by the advertisement distributor may be set in the user information table so as to be associated with the ‘association source user ID’.

The ‘association source user ID’ is identification information used by the advertisement distributor to identify the user U of the wireless terminal 5. The ‘terminal ID’ is the same as the ‘terminal ID’ in the correspondence information table illustrated in FIG. 10. In addition, the ‘association source user ID’ may be user identification information set to a hypertext transfer protocol (HTTP) cookie which is transmitted and received between the site server 8 and the wireless terminal 5, instead of the login ID of the site server 8.

The ‘demographic attributes’ indicate demographic user attribute information. The ‘demographic attributes’ are classified into, for example, attributes ‘sex’ and ‘age’ of the user U. For example, ‘1’ is stored in the attribute ‘sex’ when the user U is a female and ‘2’ is stored in the attribute ‘sex’ when the user U is a male. The age of the user U is stored in the attribute ‘age’. The ‘demographic attributes’ are not limited to the attributes illustrated in FIG. 11, but may include various attributes, such as the job, family structure, annual income, address, native place, and academic background of the user U.

The ‘psychographic attributes’ are information indicating, for example, the values, lifestyle, character, and preference of the user U. The ‘psychographic attributes’ are classified into, for example, attributes ‘car’, ‘cosmetics’, and ‘travel’. In the example illustrated in FIG. 11, ‘1’ is set to each attribute when the preference of the user U is a relatively high and ‘0’ is set to each attribute in the other cases. In addition, the ‘psychographic attributes’ are not limited to the attributes illustrated in FIG. 11, but may include various attributes, such as economy, politics, baseball, soccer, other sports, sweets, a personal computer, white goods, and furniture.

When the user information of the associated company C corresponding to the place which the wireless terminal 5 has entered is acquired, the user information extracting unit 54 adds the association source user ID of the entered user U and the company ID and the store ID corresponding to the place which the wireless terminal 5 has entered as additional information to the user information and outputs the user information to the user information output unit 55.

For example, when the user U₁ of the wireless terminal 5₁ with the terminal ID ‘T1’ enters the store A₁ of the associated company CA, the association source user ID ‘U1’, the company ID ‘CA’, and the store ID ‘A1’ are added as the additional information to the user information with the company ID ‘CA’ and the user information is output to the user information output unit 55.

In addition, the user information extracting unit 54 may add the staying state information acquired from the entry information acquiring unit 53 as the additional information to the user information and output the user information to the user information output unit 55. The additional information may be inserted into the user information acquired from the association information DB 41 or the user information DB 44 and the user information may be output to the user information output unit 55.

The user information extracting unit 54 may determine the time when the user information is acquired from the association information DB 41 or the user information DB 44 or the time when the user information is output to the user information output unit 55, based on the staying state information acquired from the entry information acquiring unit 53. In this case, it is possible to output the user information at an appropriate time corresponding to the staying state of the user U.

For example, when the number of times the same user U is in the staying state ‘loitering/long distance’ in the same store is equal to a predetermined value, the user information extracting unit 54 can acquire the user information from the association information DB 41 or the user information DB 44 or output the user information to the user information output unit 55. When the staying state of the user U is ‘staying/short distance’, the user information extracting unit 54 can instantly acquire the user information from the association information DB 41 or the user information DB 44 or output the user information to the user information output unit 55.

User information Output Unit 55

When the user information having the additional information added thereto is acquired from the user information extracting unit 54, the user information output unit 55 outputs the user information to the advertisement distribution apparatus 3 through the communication unit 30 and the communication network 7. In addition, the user information output unit 55 may not be provided and the user information extracting unit 54 may output the user information having the additional information added thereto to the advertisement distribution apparatus 3.

5. Advertisement Distribution Apparatus 3

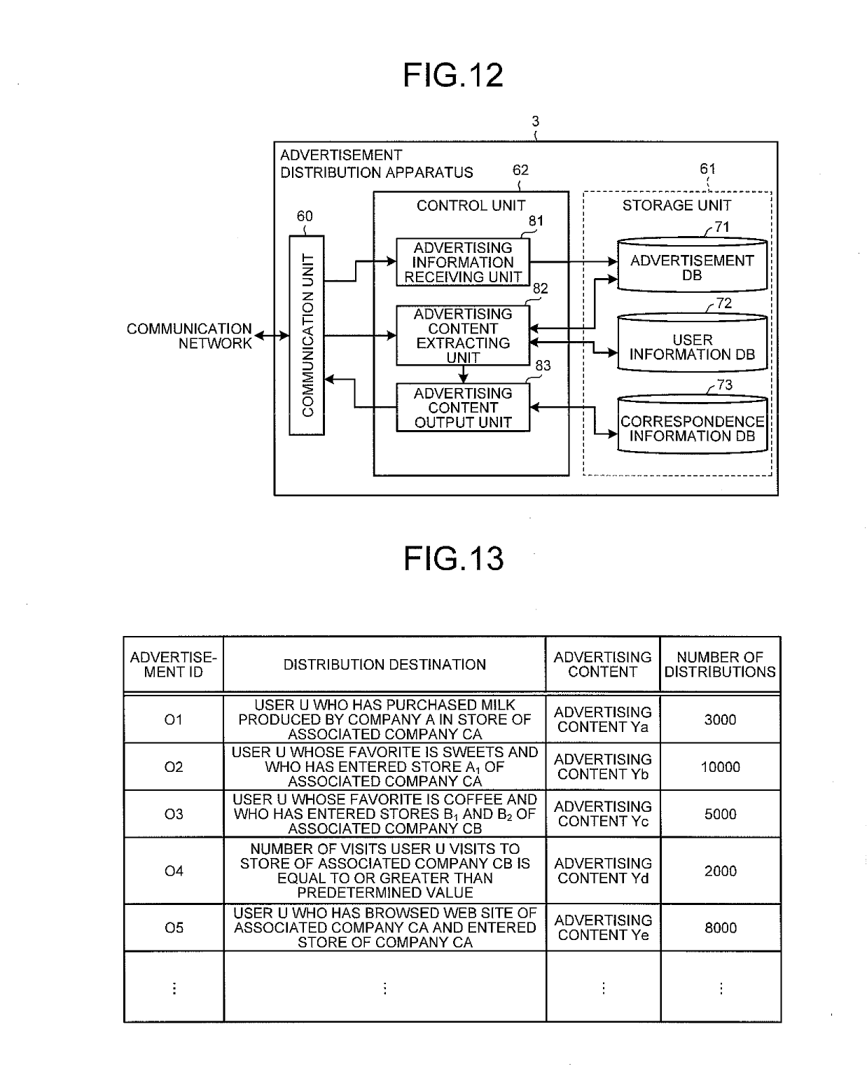

Next, the structure of the advertisement distribution apparatus 3 will be described in detail. FIG. 12 is a diagram illustrating an example of the structure of the advertisement distribution apparatus 3. As illustrated in FIG. 12, the advertisement distribution apparatus 3 includes a communication unit 60, a storage unit 61, and a control unit 62. The storage unit 61 includes an advertisement DB 71, a user information DB 72, and a correspondence information DB 73. The control unit 62 includes an advertising information receiving unit 81, an advertising content extracting unit 82, and an advertising content output unit 83.

The communication unit 60 is an interface such as NIC. The control unit 62 can transmit and receive various kinds of information to and from the user information providing apparatus 2, the information management apparatus 4, the wireless terminal 5, the wireless apparatus 6, and the site server 8 through the communication unit 60 and the communication network 7. The advertisement DB 71, the user information DB 72, and the correspondence information DB 73 are each a hard disk, a semiconductor memory element such as a RAM or a flash memory, or a storage device such as an optical disk.

The control unit 62 is implemented by, for example, an integrated circuit such as an ASIC or an FPGA. A CPU or an MPU in the control unit 62 executes the program stored in the storage device of the control unit 62 using the RAM as a work area to function as the advertising information receiving unit 81, the advertising content extracting unit 82, and the advertising content output unit 83.

The structure of the control unit 62 is not limited to the above, but the control unit 62 may have any structure as long as it can perform the following information processing. The advertisement distribution apparatus 3 includes a reading unit (not illustrated). The control unit 62 reads a program which is recorded on a recording medium to the internal storage device through the reading device and executes the program. In this way, it is possible to implement the functions of the control unit 62. Examples of the recording medium include an optical disk, a flexible disk, and a hard disk.

Advertising Information Receiving Unit 81

The advertising information receiving unit 81 receives a request to distribute advertising information from an advertiser apparatus. The advertising information includes distribution conditions, such as a distribution destination and the number of distributions, and information about the advertising content to be distributed. When the request to distribute the advertising information is received, the advertising information receiving unit 81 sets the received advertising information in an advertising information table of the advertisement DB 71.

FIG. 13 is a diagram illustrating an example of the advertising information table. As illustrated in FIG. 13, the advertising information table includes information in which ‘distribution destination’, ‘advertising content’, and ‘the number of distributions’ are associated with an ‘advertisement ID’.

The ‘advertisement ID’ is identification information which is allocated to each of the received distribution requests and is allocated by the advertising information receiving unit 81. The ‘distribution destination’ is the conditions of the distribution destination designated by the distribution request. The ‘advertising content’ is advertising content to be distributed and is, for example, a text advertisement, a still image advertisement, a moving image advertisement, an animation advertisement, or a banner advertisement.

The ‘number of distributions’ is the number of times the advertising content designated by the distribution request is distributed. In addition, the advertising information table includes distribution conditions, such as a distribution period designated by the distribution request, but the distribution period is not illustrated in the example in FIG. 13.

As illustrated in FIG. 13, as the conditions of the ‘distribution destination’, the following can be set in the advertising information table: the user U whose favorite is a predetermined product and who enters the store of the associated company C; the user U who purchases a predetermined product in the store of the associated company C; and the user U whose visits to a predetermined store of the associated company C are more than a predetermined value. In addition, for example, the user U who has browsed the web site of the associated company C may be set as the ‘distribution destination’ to the advertising information table.

Advertising Content Extracting Unit 82

The advertising content extracting unit 82 acquires the user information having the additional information added thereto from the user information providing apparatus 2 through the communication network 7 and the communication unit 60 and extracts the advertising content corresponding to the user information from the advertising information table in the advertisement DB 71.

The advertising content extracting unit 82 outputs the advertising content which is extracted from the advertising information table based on the user information to the advertising content output unit 83. In addition, the advertising content extracting unit 82 outputs the additional information acquired from the user information providing apparatus 2 to the advertising content output unit 83.

For example, it is assumed that the associated user information table is in the state illustrated in FIG. 6 and the advertising information table is in the state illustrated in FIG. 13. When the user information with the association destination user ID ‘UA1’ is acquired from the user information providing apparatus 2, the advertising content extracting unit 82 extracts, for example, ‘advertising content Ya’ with an advertisement ID ‘O1’ from the advertising information table since the purchase history of ‘milk (company A)’ is included in the user information.

For example, when the favorite food of the entered user U specified from the purchase history of the user information is ‘sweets’ and the company ID and the store ID included in the additional information are ‘CA’ and ‘A1’, respectively, the advertising content extracting unit 82 extracts, for example, ‘advertising content Yb’ with an advertisement ID ‘O2’ from the advertising information table.

For example, when the favorite food of the entered user U specified from the purchase history of the user information is ‘coffee’ and the company ID and the store ID included in the additional information are ‘CB’ and ‘B1’ or ‘B2’, respectively, the advertising content extracting unit 82 extracts, for example, ‘advertising content Yc’ with an advertisement ID ‘O3’ from the advertising information table.

For example, when the number of times the entered user U visits the store of the associated company CB, which is determined from the store visit history of the user information, is equal to or greater than a predetermined value, the advertising content extracting unit 82 extracts, for example, ‘advertising content Yd’ with an advertisement ID ‘O4’ from the advertising information table.

When the user information acquired from the user information providing apparatus 2 is all user information of the associated company C corresponding to the place which the user U has entered or the user information of the store which the user U has entered, the advertising content extracting unit 82 extracts the advertising content from the advertising information table based on the user information.

For example, the advertising content extracting unit 82 determines the business conditions of the associated company C from the user information acquired from the user information providing apparatus 2 and extracts the advertising content related to the determined business conditions from the advertising information table. The business conditions of the associated company C determined by the advertising content extracting unit 82 include, for example, the type of business of the associated company C, the type of goods or services provided by the associated company C, the content of goods or services, and the number of goods or services provided.

As such, the advertising content extracting unit 82 can select the advertising content based on the user information of the associated company C. Therefore, it is possible to limit the user U related to the associated company C to an advertisement distribution target. As a result, it is possible to perform high-accuracy targeting advertisement.

When it is difficult to select the advertising content based on the user information acquired from the user information providing apparatus 2, the advertising content extracting unit 82 may select the advertising content based on the additional information. In this case, for example, the advertising content extracting unit 82 can acquire the user information corresponding to the association source user ID which is included in the additional information from a user information table in the user information DB 72 and use the acquired user information. For example, the user information table in the user information DB 72 is the same information as the user information table in the user information providing apparatus 2.

The advertising content extracting unit 82 can specify the associated company C having the store which the user U has entered based on the company ID included in the additional information. In addition, the advertising content extracting unit 82 can specify the store which the user U has entered based on the store ID included in the additional information. The advertising content extracting unit 82 can specify the attributes of the entered user U based on the user information table in the user information DB 72 or can specify, for example, the preference or behavior of the user based on the access log to the site.

Therefore, when it is determined that the user U has browsed the web site of the associated company CA provided by the site server 8 and then entered the store of the associated company CA based on the additional information and the user information in the user information DB 72, the advertising content extracting unit 82 extracts ‘advertising content Ye’ with an advertisement ID ‘O5’ from the advertising information table.

The advertising content extracting unit 82 may select the advertising content based on the staying state information. For example, the advertising content extracting unit 82 can select the advertising content in which, for example, the ‘staying time of the user in the store’, ‘passing an area around the store’, and ‘loitering around the store’ are designated as the distribution conditions, based on the staying state information.

When a request to transmit the advertising content in which the association source user ID is designated is transmitted from the site server 8, the advertising content extracting unit 82 acquires the user information corresponding to the association source user ID from the user information table in the user information DB 72 and extracts the advertising content corresponding to the acquired user information from the advertisement DB 71. For example, when it is determined that the user U with the association source user ID has a relatively high preference for a ‘car’ based on the user information corresponding to the association source user ID, the advertising content extracting unit 82 extracts, from the advertisement DB 71, the advertising content corresponding to the distribution conditions in which the user U with a relatively high preference for the ‘car’ is designated as the distribution destination.

Advertising Content Output Unit 83

The advertising content output unit 83 outputs the advertising content which is extracted by the advertising content extracting unit 82 based on the user information transmitted from the user information providing apparatus 2 to the wireless terminal 5 which has entered the place corresponding to the associated company C.

For example, the advertising content output unit 83 transmits the advertising content which designates the wireless terminal 5 with the terminal ID to the wireless apparatus 6 which is installed in the place corresponding to the associated company C. When receiving the advertising content which designates the wireless terminal 5 from the advertisement distribution apparatus 3, the wireless apparatus 6 transmits the advertising content to the wireless terminal 5 specified by the terminal ID. Then, the advertising content related to the place corresponding to the associated company C is displayed on the wireless terminal 5.

When the store ID is the network address of the wireless apparatus 6 on the side of the communication network 7, the advertising content output unit 83 transmits the advertising content from the communication unit 60 to the communication network 7 using the store ID output from the advertising content extracting unit 82 as a destination. In this way, the advertising content is transmitted from the advertisement distribution apparatus 3 to the wireless apparatus 6.

A correspondence information table which is the same as the correspondence information table of the user information providing apparatus 2 is stored in the correspondence information DB 73 and the wireless terminal 5 which has entered the place corresponding to the associated company C is designated based on the correspondence information table. For example, when the association destination user ID output from the advertising content extracting unit 82 is ‘U1’, the terminal ID ‘T1’ is designated and the advertising content is transmitted to the wireless apparatus 6. In this way, the advertising content is distributed from the wireless apparatus 6 to the wireless terminal 5 which has entered the place corresponding to the associated company C.

A method of outputting the advertising content to the wireless terminal 5 which has entered the place corresponding to the associated company C is not limited to the transmission of the advertising content from the wireless apparatus 6. For example, when the wireless terminal 5 which has entered the place corresponding to the associated company C accesses the site server 8, the advertising content and the association source user ID may be transmitted to the site server 8 such that the advertising content can be inserted into an access destination page. In this case, the site server 8 inserts the advertising content acquired from the advertisement distribution apparatus 3 into the access destination page and transmits the access destination page to the wireless terminal 5 which logs in using the association source user ID.

When the mail address of the wireless terminal 5 which has entered the place corresponding to the associated company C is set in the correspondence information table, the advertising content may be output to the wireless terminal 5 by electronic mail. When a WAN-ID is associated with the association destination user ID in the correspondence information table, the advertising content output unit 83 transmits the advertising content to the communication network 7 using the WAN-ID as a destination. In this way, it is possible to directly transmit the advertising content to the wireless terminal 5.

6. Process Flow of Advertisement Distribution System 1

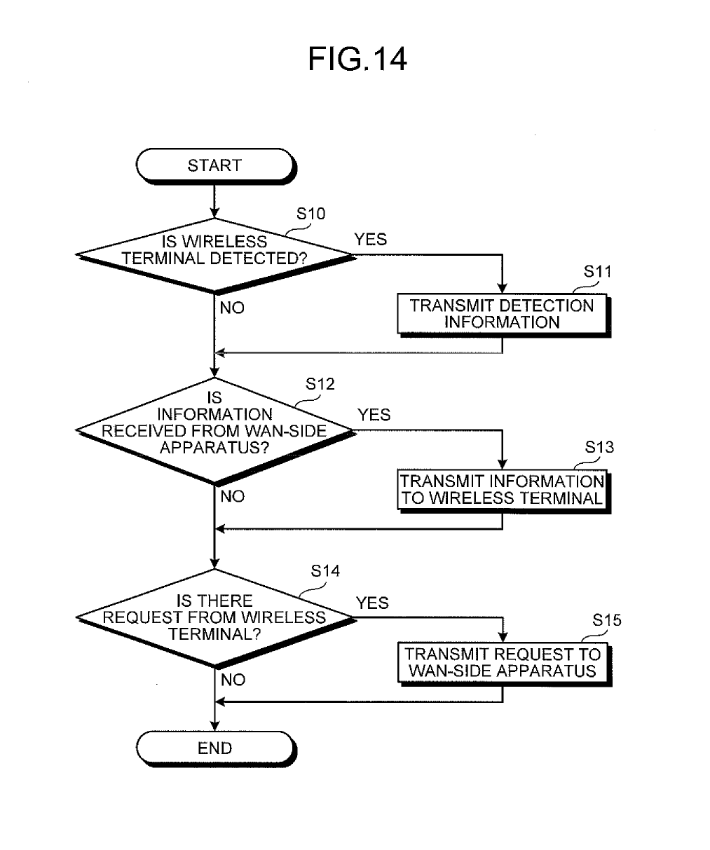

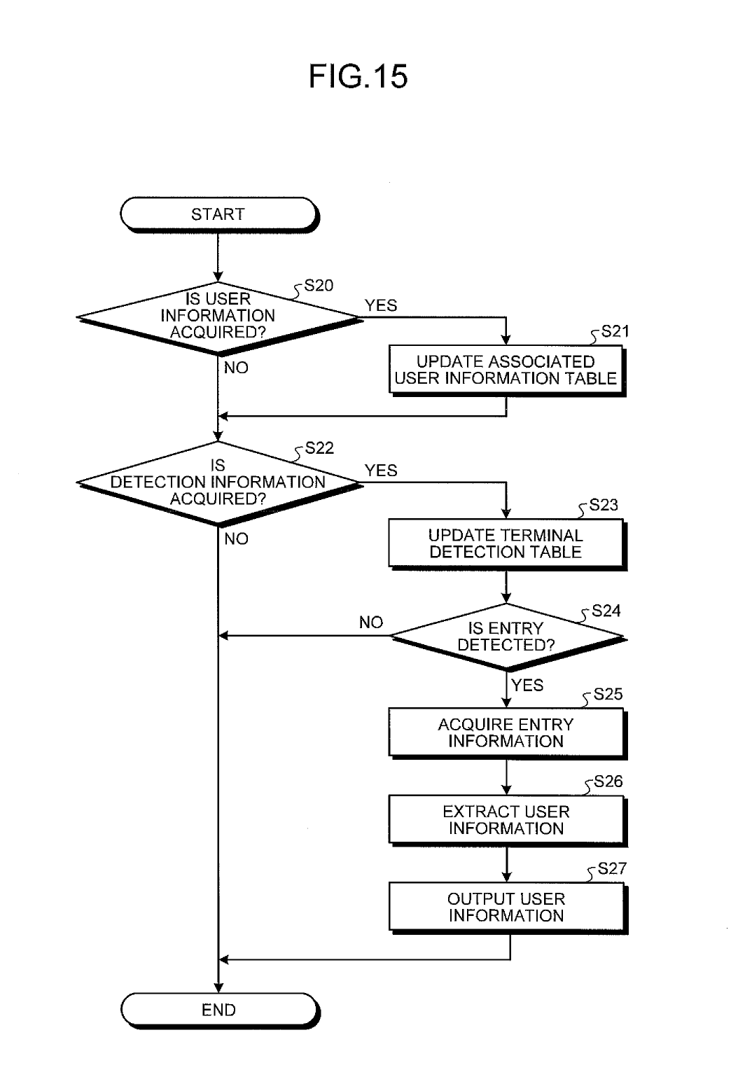

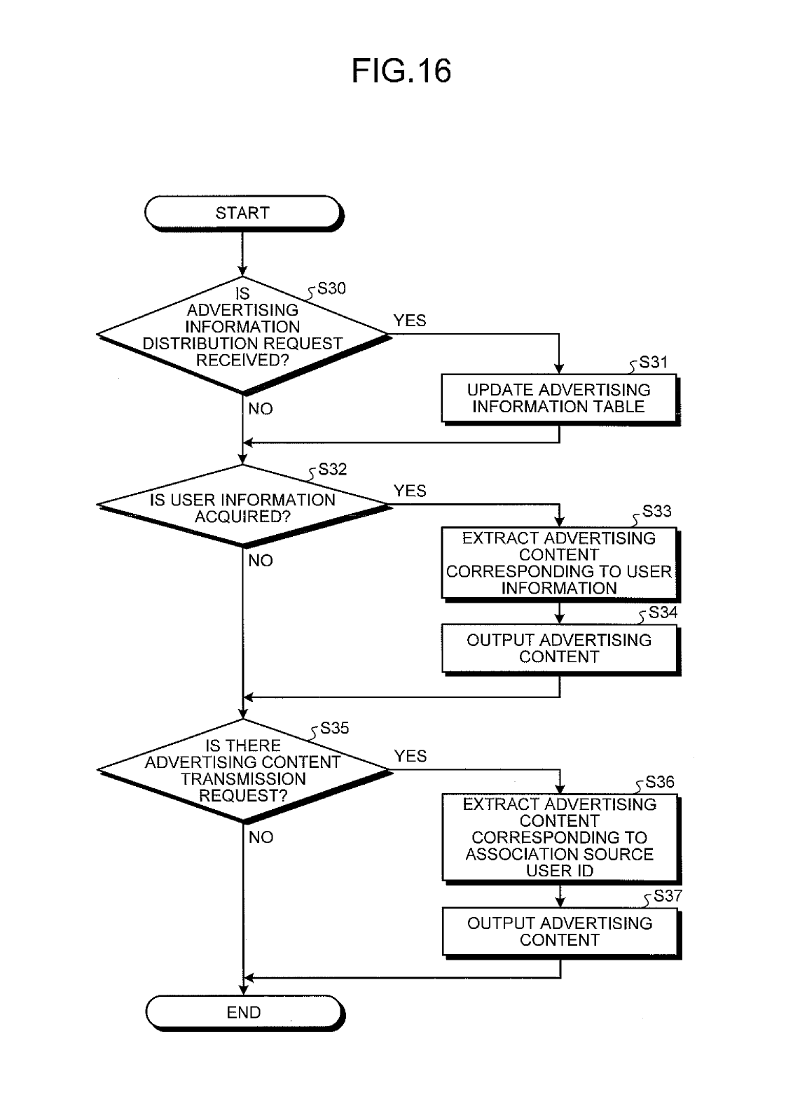

Next, the procedure of an information providing process performed by the advertisement distribution system 1 according to the embodiment will be described. FIGS. 14 to 16 are diagrams illustrating the flow of the information providing process performed by the advertisement distribution system 1. Hereinafter, the information processing operation of the wireless apparatus 6 will be described with reference to FIG. 14. The information processing operation of the user information providing apparatus 2 will be described with reference to FIG. 15. The information processing operation of the advertisement distribution apparatus 3 will be described with reference to FIG. 16.

Process of Wireless Apparatus 6

First, the information processing operation of the wireless apparatus 6 according to the embodiment will be described. FIG. 14 is a flowchart illustrating the information processing operation of the wireless apparatus 6 according to the embodiment. The information processing operation is repeatedly performed by the control unit 23 of the wireless apparatus 6.

As illustrated in FIG. 14, the control unit 23 of the wireless apparatus 6 determines whether the wireless terminal 5 has been detected (Step S10). When it is determined that the wireless terminal 5 has been detected (Yes in Step S10), the control unit 23 transmits detection information to the user information providing apparatus 2 through the WAN communication unit 22 (Step S11).

When it is determined in Step S10 that the wireless terminal 5 has not been detected (No in Step S10), or when Step S11 ends, the control unit 23 determines whether information has been received from a WAN-side apparatus connected to the communication network 7 through the WAN communication unit 22 (Step S12). When it is determined that information has been received from the WAN-side apparatus (Yes in Step S12), the control unit 23 transmits the received information to the wireless terminal 5 which is the destination of the information (Step S13).

When it is determined in Step S12 that information has not been received (No in Step S12) or when Step S13 ends, the control unit 23 determines whether there is a request of the wireless terminal 5 to the WAN-side apparatus (Step S14). When it is determined that there is a request of the wireless terminal 5 to the WAN-side apparatus (Yes in Step S14), the control unit 23 transmits the request of the wireless terminal 5 to the WAN-side apparatus to the WAN-side apparatus through the WAN communication unit 22 (Step S15).

When Step S15 ends or when it is determined in Step S11 that there is no request of the wireless terminal 5 to the WAN-side apparatus (No in Step S14), the control unit 23 ends the process.

Process of User Information Providing Apparatus 2

Next, the information processing operation of the user information providing apparatus 2 will be described. FIG. 15 is a flowchart illustrating the information processing operation of the user information providing apparatus 2 according to the embodiment. The information processing operation is repeatedly performed by the control unit 32 of the user information providing apparatus 2.

As illustrated in FIG. 15, the control unit 32 determines whether the user information of the associated company C has been acquired from the information management apparatus 4 or the wireless apparatus 6 through the communication unit 30 (Step S20). When it is determined that the user information of the associated company C has been acquired (Yes in Step S20), the control unit 32 sets the acquired user information in the associated user information table of the association information DB 41 to update the associated user information table (Step S21).

Then, when it is determined in Step S20 that the user information of the associated company C has not been acquired (No in Step S20) or when Step S21 ends, the control unit 32 determines whether the detection information transmitted from the wireless apparatus 6 has been acquired through the communication unit 30 (Step S22). When it is determined that the detection information has been acquired (Yes in Step S22), the control unit 32 updates the terminal detection table based on the acquired detection information (Step S23).

Then, the control unit 32 determines whether the wireless terminal 5 has entered the place corresponding to the associated company C based on the updated terminal detection table (Step S24). When it is determined that the wireless terminal 5 has entered the place corresponding to the associated company C (Yes in Step S24), the control unit 32 acquires the entry information from the terminal detection table (Step S25). The entry information includes, for example, the information (for example, the company ID or the store ID) of the place corresponding to the associated company C which the wireless terminal 5 has entered and the information (for example, the terminal ID) of the wireless terminal 5 which has entered the place.

Then, the control unit 32 extracts the user information of the associated company C corresponding to the place which the wireless terminal 5 has entered from the association information DB 41 based on the entry information (Step S26). Then, the control unit 32 outputs the user information of the associated company C extracted in Step S26 to the advertisement distribution apparatus 3 (Step S27). Additional information is added to the user information.

When it is determined that the detection information has not been acquired (No in Step S22), when the wireless terminal 5 has not entered the place corresponding to the associated company C (No in Step S24), or when Step S27 ends, the control unit 32 ends the process.

Process of Advertisement Distribution Apparatus 3

Next, the information processing operation of the advertisement distribution apparatus 3 will be described.

FIG. 16 is a flowchart illustrating the information processing operation of the advertisement distribution apparatus 3 according to the embodiment. The information processing operation is repeatedly performed by the control unit 62 of the advertisement distribution apparatus 3.

As illustrated in FIG. 16, the control unit 62 determines whether an advertising information distribution request has been received from the advertiser apparatus through the communication unit 60 (Step S30). When it is determined that the advertising information distribution request has been received (Yes in Step S30), the control unit 62 sets the advertising information included in the distribution request in the advertising information table of the advertisement DB 71 (Step S31).

When it is determined that the advertising information distribution request has not been received (No in Step S30) or when Step S31 ends, the control unit 62 determines whether the user information having the additional information added thereto has been acquired from the user information providing apparatus 2 (Step S32). When it is determined that the user information has been acquired (Yes in Step S32), the control unit 62 extracts the advertising content corresponding to the acquired user information from the advertisement DB 71 (Step S33) and outputs the extracted advertising content to the site server 8 (Step S34).

When it is determined that the user information has not been acquired (No in Step S32) or when Step S34 ends, the control unit 62 determines whether there is a request to transmit the advertising content which designates the association source user ID from the site server 8 (Step S35). When it is determined that there is the advertising content transmission request (Yes in Step S35), the control unit 62 acquires the user information corresponding to the association source user ID included in the transmission request from the user information DB 72 and extracts the advertising content corresponding to the acquired user information from the advertisement DB 71 (Step S36).

Then, the control unit 62 outputs the advertising content extracted from the advertisement DB 71 to the site server 8 (Step S37). When it is determined that there is no advertising content transmission request (No in Step S35) or when Step S37 ends, the control unit 62 ends the process.

7. Modifications

In a case where the distribution conditions of the distribution destination designated by the distribution request from the advertiser apparatus designate the user U related to the associated company C, only when the advertiser is the associated company C, the advertising information receiving unit 81 of the advertisement distribution apparatus 3 can receive the distribution request.

For example, the advertising information receiving unit 81 may receive a request to distribute the advertising information in which the ‘user U whose favorite is a predetermined product and who has entered the store of the associated company CA’ is designated as the distribution destination only when the advertiser is the associated company CA. In addition, the advertising information receiving unit 81 may receive a request to distribute the advertising information in which the ‘user U who has browsed the web site of the associated company CA’ is designated as the distribution destination only when the advertiser is the associated company CA.

The advertising information receiving unit 81 can receive the distribution request only when the associated companies C contact with each other to use information. For example, when the associated companies CA and CB contract with each other to use information, the information is stored as mutually-usable information in the advertisement DB 71. In a case where the user U related to the associated company CA is designated based on the mutually-usable information stored in the advertisement DB 71, only when the advertiser is the associated company CA or the associated company CB, the advertising information receiving unit 81 can receive the distribution request.

For example, the customer may be limited for each associated company C. For example, when the advertisers are manufacturers A and B, the associated company CA can receive a distribution request which designates the user U related to the associated company CA. Customer limitation information for each associated company C is stored in the advertisement DB 71. For example, in a case where the user U related to the associated company CA is designated based on the customer limitation information stored in the advertisement DB 71, only when the advertiser is the associated company CA or the manufacturers A and B, the advertising information receiving unit 81 can receive the distribution request.

The user information may be used between the associated companies C which contract with each other to use information. For example, in a case where the associated companies CA and CB contract with each other to use information, when there is no user information of the associated company CA, the advertising content extracting unit 82 can extract the user information of the associated company CB based on the mutually-usable information stored in the advertisement DB 71. Even when there is the user information of the associated company CA, the advertising content extracting unit 82 can extract the user information of the associated company CA and the user information of the associated company CB as one user information item.

Only the associated company CA can access the user information of the associated company CA and only the associated company CB can access the user information of the associated company CB. However, user information which can be accessed by each associated company C may be separately set. For example, the user information can be set such that the associated company CA can access the user information of the associated company CB and the associated company CB can access the user information of the associated company CA. For access to the user information of each associated company C, for example, the user information extracting unit 54 can receive a request from the apparatus of the associated company C and accept or reject access to the user information based on an access right set to each associated company C.

As described above, the user information of the associated company C includes the store visit history. However, the store visit history may be set based on the detection information from the wireless apparatus 6. For example, the control unit of the information management apparatus 4 may acquire the detection information from the wireless apparatus 6, determine whether the wireless terminal 5 has entered the store of the associated company C using the same process as that of the terminal entry detection unit 52 of the user information providing apparatus 2, and update the store visit history of the user U who visits the store of the associated company C based on the determination result.

8. Effect

The user information providing apparatus 2 in the advertisement distribution system 1 according to the embodiment includes the association information DB 41 (an example of a business operator information DB), the entry information acquiring unit 53, the user information extracting unit 54, and the user information output unit 55. The association information DB 41 stores the user information of the associated company C (an example of a business operator). The entry information acquiring unit 53 acquires, as the entry information, the information of the place corresponding to the associated company C and the information of the wireless terminal 5 which has entered the place corresponding to the associated company C. The user information extracting unit 54 extracts the user information of the associated company C corresponding to the place which the wireless terminal 5 has entered from the association information DB 41, based on the entry information acquired by the entry information acquiring unit 53. The user information output unit 55 outputs the user information extracted by the user information extracting unit 54.

Therefore, it is possible to distribute the advertising content only to the user U of the associated company C. As a result, it is possible to effectively and accurately promote the purchase of goods.

The user information extracting unit 54 can extract, from the association information DB 41, the piece of user information corresponding to the entered user U among the pieces of user information of the associated company C corresponding to the place which the wireless terminal 5 has entered.

Therefore, it is possible to distribute the advertising content corresponding to the user information of the entered user U among the users U of the associated company C and effectively and accurately promote goods.

The user information extracting unit 54 can extract, from the association information DB 41, the piece of user information of the place which the wireless terminal 5 has entered, among the pieces of user information of the associated company C corresponding to the place which the wireless terminal 5 has entered.

Therefore, it is possible to distribute the advertising content corresponding to the user information of the place which the wireless terminal 5 has entered and thus effectively and accurately promote the purchase of goods.

The user information extracting unit 54 can extract, from the association information DB 41, the piece of user information which corresponds to the entered user U and is of the store which the wireless terminal 5 has entered among the pieces of user information of the associated company C corresponding to the place which the wireless terminal 5 has entered.

Therefore, it is possible to distribute the advertising content corresponding to the user information of the place which the wireless terminal 5 has entered to the user U of the associated company C and thus effectively and accurately promote the purchase of goods.

The user information providing apparatus 2 includes the terminal entry detection unit 52 which detects the entry of the wireless terminal 5 to the place corresponding to the associated company C based on the information transmitted from the wireless apparatus 6 (an example of the wireless LAN access point) having the place corresponding to the associated company C as a communication area. The entry information acquiring unit 53 acquires the entry information from the terminal entry detection unit 52.

Therefore, when the wireless LAN access point is provided in the place corresponding to the associated company C, it is possible to detect the entry of the wireless terminal 5 to the place corresponding to the associated company C, without providing another wireless apparatus.

When the staying time of the wireless terminal 5 in the communication area of the wireless apparatus 6 and/or the radio field strength of the wireless terminal 5 acquired by the wireless apparatus 6 satisfy predetermined conditions, the terminal entry detection unit 52 detects that the wireless terminal 5 has entered the place corresponding to the associated company C.

Therefore, for example, it is possible to easily set the range in which the entry of the wireless terminal 5 is detected in the communication area of the wireless apparatus 6. For example, it is possible to exclude the wireless terminal 5 which stays in the communication area of the wireless apparatus 6 in a short time and has less to do with the associated company C.

The terminal entry detection unit 52 changes predetermined conditions based on the set information transmitted from the wireless terminal 5.

Therefore, the user U of the wireless terminal 5 can set the staying time or the radio field strength. For example, the user U of the wireless terminal 5 can adjust the entry detection sensitivity of the wireless terminal 5.

The user information providing apparatus 2 includes the user information acquiring unit 51 which acquires the user information possessed by each of a plurality of associated companies C. The association information DB 41 stores the user information of the plurality of associated companies C acquired by the user information acquiring unit 51.

Therefore, it is possible to provide the user information of a plurality of associated companies C and distribute the advertising content only to the user of each associated company C. As a result, it is possible to effectively and accurately promote the purchase of goods.

The user information providing apparatus 2 includes the user information DB 44 which stores the user information possessed by the advertisement distributor (an example of a business operator different from the plurality of associated companies C). When the piece of user information corresponding to the entered user U among the pieces of user information of the associated company C corresponding to the place which the wireless terminal 5 has entered is not stored in the association information DB 41, the user information extracting unit 54 extracts the user information corresponding to the user U of the wireless terminal 5 from the user information DB 44.

Therefore, even when there is no user information of the associated company C corresponding to the place which the wireless terminal 5 has entered, it is possible to output the user information of the entered user U. In this case, the user information is output based on the information from the place which the wireless terminal 5 has entered. Therefore, the advertisement distributor may pay a reward to the associated company C corresponding to the place which the wireless terminal 5 has entered.

The user information includes the information of a behavior history in the facilities or stores of the associated company C.

Therefore, the user information providing apparatus 2 can output the user information including the behavior history in the facilities or stores of the associated company C. It is possible to distribute the advertising content corresponding to the behavior history of the user U of the associated company C and thus effectively and accurately promote the purchase of goods.

The advertisement distribution system 1 according to the embodiment includes the advertisement distribution apparatus 3. The advertisement distribution apparatus 3 includes the advertisement DB 71, the advertising content extracting unit 82, and the advertising content output unit 83. The advertisement DB 71 stores advertising content and distribution information including the distribution conditions. The advertising content extracting unit 82 extracts the advertising content corresponding to the user information output from the user information providing apparatus 2 from the advertisement DB 71. The advertising content output unit 83 outputs the advertising content extracted from the advertising content extracting unit 82 to the wireless terminal 5 which has entered the place corresponding to the associated company C.

Therefore, the advertiser sends the advertising information including the distribution conditions which designate the associated company C and the user attributes (for example, the preference or interest of the user U), which makes it possible to distribute the advertising content to the wireless terminal 5 of the user U having the designated user information among the users U who use the associated company C. In addition, the advertiser inserts the designation of the store into the distribution conditions, which makes it possible to distribute the advertising content to the wireless terminal 5 of the user U having the user information corresponding to the designated store. Therefore, for example, when the manufacturer that provides goods to be placed in the store of the associated company C as the advertiser sends the advertising information to the advertisement distribution apparatus 3, it is possible to distribute the advertising content only to the user U of the associated company C and thus effectively and accurately promote the purchase goods. Since the user information of the associated company C includes the purchase history of the goods of the manufacturer, it is possible to distribute the advertising content only to the user U which has purchased the goods advertised by the advertising content. Therefore, it is possible to effectively and accurately promote the purchase goods.

9. Others

Some embodiments of the invention have been described in detail above with reference to the drawings. The embodiments are illustrative, and various modifications and changes of the invention including the aspects described in the Detailed Description of the Embodiments can be made based on knowledge of those skilled in the art.

The user information providing apparatus 2 and the advertisement distribution apparatus 3 may be implemented by one server computer. In addition, the user information providing apparatus 2 or the advertisement distribution apparatus 3 may be implemented by a plurality of server computers and the structure of the apparatuses may be flexibly changed depending on the functions. For example, an external platform may be called by an application programming interface (API) or network computing and then executed to implement the apparatuses.

According to an embodiment, it is possible to provide a user information providing apparatus, a user information providing method, a user information providing program, and an advertisement distribution system capable of performing high-accuracy targeting advertisement.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A user information providing apparatus comprising:
a business operator information database configured to store pieces of user information of a business operator;
an entry information acquiring unit configured to acquire, as entry information, information of a place corresponding to the business operator and information of a wireless terminal which has entered the place;
a user information extracting unit configured to extract a piece of user information of the business operator corresponding to the place which the wireless terminal has entered from the business operator information database, based on the entry information acquired by the entry information acquiring unit; and
a user information output unit configured to output the piece of user information extracted by the user information extracting unit.

2. The user information providing apparatus according to claim 1, wherein the user information extracting unit extracts, from the business operator information database, a piece of user information corresponding to a user of the wireless terminal among the pieces of user information of the business operator corresponding to the place which the wireless terminal has entered.

3. The user information providing apparatus according to claim 1, wherein the user information extracting unit extracts, from the business operator information database, a piece of user information of the place which the wireless terminal has entered among the pieces of user information of the business operator corresponding to the place which the wireless terminal has entered.

4. The user information providing apparatus according to claim 1, wherein the user information extracting unit extracts, from the business operator information database, a piece of user information corresponding to a user of the wireless terminal and the place which the wireless terminal has entered among the pieces of user information of the business operator corresponding to the place which the wireless terminal has entered.

5. The user information providing apparatus according to claim 1, further comprising:
a terminal entry detection unit configured to detect the entry of the wireless terminal to the place corresponding to the business operator based on information transmitted from a wireless LAN access point which has a communication area corresponding to the place,
wherein the entry information acquiring unit acquires the entry information from the terminal entry detection unit.

6. The user information providing apparatus according to claim 5, wherein the terminal entry detection unit detects that the wireless terminal has entered the place corresponding to the business operator when a staying time of the wireless terminal in the communication area of the wireless LAN access point and/or radio field strength of the wireless terminal acquired by the wireless LAN access point satisfy predetermined conditions.

7. The user information providing apparatus according to claim 6, wherein the terminal entry detection unit changes the predetermined conditions based on set information transmitted from the wireless terminal.

8. The user information providing apparatus according to claim 1, further comprising:
a user information acquiring unit configured to acquire pieces of user information possessed by each of a plurality of business operators,
wherein the business operator information database stores the pieces of user information of the plurality of business operators acquired by the user information acquiring unit.

9. The user information providing apparatus according to claim 2, further comprising:
a user information database configured to store pieces of user information possessed by a business operator different from the plurality of business operators,
wherein the user information extracting unit extracts a piece of user information corresponding to the user of the wireless terminal from the user information database when the piece of user information corresponding to the user of the wireless terminal among the pieces of user information of the business operator corresponding to the place which the wireless terminal has entered is not stored in the business operator information database.

10. The user information providing apparatus according to claim 4, further comprising:
a user information database configured to store pieces of user information possessed by a business operator different from the plurality of business operators,
wherein the user information extracting unit extracts a piece of user information corresponding to the user of the wireless terminal from the user information database when the piece of user information corresponding to the user of the wireless terminal among the pieces of user information of the business operator corresponding to the place which the wireless terminal has entered is not stored in the business operator information database.

11. The user information providing apparatus according to claim 1, wherein the user information includes information of a behavior history in facilities or stores of the business operator.

12. An advertisement distribution system comprising:
a user information providing apparatus; and
an advertisement distribution apparatus,
wherein the user information providing apparatus includes:
a business operator information database configured to store pieces of user information of a business operator;
an entry information acquiring unit configured to acquire, as entry information, information of a place corresponding to the business operator and information of a wireless terminal which has entered the place;
a user information extracting unit configured to extract a piece of user information of a business operator corresponding to the place which the wireless terminal has entered from the business operator information database, based on the entry information acquired by the entry information acquiring unit; and
a user information output unit configured to output the piece of user information extracted by the user information extracting unit, wherein
the advertisement distribution apparatus includes:
an advertisement database configured to store piece of advertising content;
an advertising content extracting unit configured to extract a piece of advertising content corresponding to the piece of user information output from the user information providing apparatus from the advertisement database; and
an advertising content output unit configured to output the piece of advertising content extracted from the advertising content extracting unit to the wireless terminal which has entered the place corresponding to the business operator.

13. A user information providing method performed by a computer, comprising:
acquiring, as entry information, information of a place corresponding to the business operator and information of a wireless terminal which has entered the place;
extracting a piece of user information of the business operator corresponding to the place which the wireless terminal has entered from a business operator information database which stores pieces of user information of the business operator, based on the acquired entry information; and
outputting the extracted piece of user information.

14. The user information providing method apparatus according to claim 13, wherein the extracting includes extracting, from the business operator information database, a piece of user information corresponding to a user of the wireless terminal among the pieces of user information of the business operator corresponding to the place which the wireless terminal has entered.

15. The user information providing method according to claim 13, wherein the extracting includes extracting, from the business operator information database, a piece of user information of the place which the wireless terminal has entered among the pieces of user information of the business operator corresponding to the place which the wireless terminal has entered.

16. The user information providing method according to claim 13, wherein the extracting includes extracting, from the business operator information database, a piece of user information corresponding to a user of the wireless terminal and the place which the wireless terminal has entered among the pieces of user information of the business operator corresponding to the place which the wireless terminal has entered.

17. The user information providing method according to claim 13, further comprising:
detecting the entry of the wireless terminal to the place corresponding to the business operator based on information transmitted from a wireless LAN access point which has a communication area corresponding to the place,
wherein the acquiring includes acquiring the detected entry information.

18. The user information providing method according to claim 17, wherein the detecting includes detecting that the wireless terminal has entered the place corresponding to the business operator when a staying time of the wireless terminal in the communication area of the wireless LAN access point and/or radio field strength of the wireless terminal acquired by the wireless LAN access point satisfy predetermined conditions.

19. The user information providing method according to claim 18, wherein the detecting includes changing the predetermined conditions based on set information transmitted from the wireless terminal.

20. A non-transitory computer readable storage medium containing program instructions for providing information, wherein execution of the program instructions by one or more processors of a computer system causes the one or more processors to perform:
acquiring, as entry information, information of a place corresponding to the business operator and information of a wireless terminal which has entered the place;
extracting a piece of user information of the business operator corresponding to the place which the wireless terminal has entered from a business operator information database which stores pieces of user information of the business operator, based on the acquired entry information; and
outputting the extracted piece of user information.
